(19) United States
(12) Patent Application Publication
(10) Pub. No.: US 2023/0066592 A1
(43) Pub. Date: Mar. 2, 2023

(54) Door Movement and Robot Traversal Using Machine Learning Object Detection

(71) Applicant: Boston Dynamics, Inc., Waltham, MA (US)

(72) Inventors: Richard McRae Shanor, San Francisco, CA (US); Stephen George Berard, Burlington, MA (US); Andrew James Barry, Cambridge, MA (US)

(21) Appl. No.: 17/898,206

(22) Filed: Aug. 29, 2022

Related U.S. Application Data
(60) Provisional application No. 63/260,746, filed on Aug. 31, 2021.

(51) Int. Cl. B25J 9/16; G05D 1/02; B62D 57/032; G06T 7/60; G06V 10/764

(52) U.S. Cl. CPC B25J 9/1697; G05D 1/0231; B62D 57/032; G06T 7/60; G06V 10/764

(57) ABSTRACT

A computer-implemented method executed by data processing hardware of a robot causes the data processing hardware to receive sensor data associated with a door. The data processing hardware determines, using the sensor data, door properties of the door. The door properties can include a door width, a grasp search ray, a grasp type, a swing direction, or a door handedness. The data processing hardware generates a door movement operation based on the door properties. The data processing hardware can execute the door movement operation to move the door. The door movement operation can include pushing the door, pulling the door, hooking a frame of the door, or blocking the door. The data processing hardware can utilize the door movement operation to enable a robot to traverse a door without human intervention.

### CROSS REFERENCE TO RELATED APPLICATIONS

This application claims priority under 35 U.S.C. § 119(e) to U.S. Provisional Application 63/260,746, filed on Aug. 31, 2021. The disclosure of this prior application is considered part of the disclosure of this application and is hereby incorporated by reference in its entirety.

### TECHNICAL FIELD

This disclosure relates to door movement using machine learning object detection.

### BACKGROUND

A robot can include a reprogrammable and multifunctional manipulator to move material, parts, tools, or specialized devices through variable programmed motions for performance of tasks. The manipulator may be physically anchored (e.g., industrial robotic arms) or may be anchored to a mobile robot. For example, mobile robots that move throughout an environment (e.g., via legs, wheels, or traction based mechanisms) can include the manipulator.

### SUMMARY

An aspect of the present disclosure provides a computer-implemented method that when executed by data processing hardware of a robot causes the data processing hardware to perform operations. The operations include receiving, from a sensor of a robot, sensor data associated with at least a portion of a door. The operations further include determining, using the sensor data, one or more door properties of the door. Further, the operations include generating, using the one or more door properties, a door movement operation executable by the robot to move the door.

In some implementations, determining the one or more door properties includes executing a door detection model to receive, as input, the sensor data and generate, as output, the one or more door properties.

In some implementations, the sensor data includes image data associated with at least one of a door frame, a door handle, a door hinge, a door knob, or a door pushbar.

In some implementations, the one or more door properties include at least one of a door width, a grasp search ray, a grasp type, a swing direction, or a door handedness.

In some implementations, the sensor data is associated with at least a portion of a door frame. Further, the one or more door properties can include an estimated door width and the door movement operation can include positioning a distal end of a leg of the robot in a placement location to block the door from swinging in a particular direction.

In some implementations, the sensor data is associated with at least a portion of a door frame. Further, the one or more door properties can include an estimated door width and the door movement operation can include positioning an end-effector of a manipulator arm of the robot at an arm placement location on the door. Positioning the end-effector at the arm placement location can include hooking the end-effector around an edge of the door. The manipulator arm can extend from a first side of the door around an edge of the door to a second side of the door.

In some implementations, the sensor data is associated with at least a portion of a door frame. Further, the one or more door properties can include an estimated door width and the door movement operation can include positioning an end-effector of a manipulator arm of the robot at an arm placement location on the door. The end-effector of the manipulator arm can exert a push force at a location on the door corresponding to the arm placement location to enable the robot to traverse the door.

In some implementations, the sensor data is associated with at least a portion of a door handle. Further, the one or more door properties can include a grasping ray indicating an estimated spatial location of the door handle relative to an end-effector of a manipulator arm of the robot. Further, the door movement operation can include grasping the door handle with the end-effector at the estimated spatial location.

In some implementations, the sensor data is associated with at least a portion of a door handle. Further, the one or more door properties can include a classification of the door handle. Further, the door movement operation can include grasping the door handle with the end-effector based on the classification of the door handle. The classification of the door handle can indicate the door handle comprises at least one of a pushbar, a handle, or a knob.

In some implementations, the sensor data is associated with at least a portion of a door hinge. Further, the one or more door properties can include a door handedness and the door movement operation can include exerting a pull force with an end-effector of a manipulator arm of the robot based on determining that the one or more door properties indicate that the door opens by swinging in a direction towards the robot.

In some implementations, the sensor data is associated with at least a portion of a door hinge. Further, the one or more door properties can include a door handedness and the door movement operation can include exerting a push force with an end-effector of a manipulator arm of the robot based on determining that the one or more door properties indicate that the door opens by swinging in a direction away from the robot.

In some implementations, the robot includes a manipulator arm. Further, the manipulator arm can include an end-effector. Further, the sensor can be located on the end-effector

In some implementations, the sensor is located on a body of the robot.

In some implementations, the robot includes four legs, each of the four legs coupled to a body of the robot.

In some implementations, the one or more door properties identify a state of the door as a fully open state, a partially open state, or a closed state.

In some implementations, the operations further include executing the door movement operation to move the robot according to the door movement operation.

In some implementations, the door movement operation is executed by the robot without human intervention.

Another aspect of the present disclosure provides a robot. The robot includes a body, two or more legs coupled to the body, a robotic manipulator coupled to the body, data processing hardware, and memory hardware in communication with the data processing hardware. The memory hardware stores instructions that when executed on the data processing hardware cause the data processing hardware to perform operations. The operations include receiving, from a sensor of a robot, sensor data associated with at least a portion of a door. The operations further include determining, using the sensor data, one or more door properties of the door. The operations further include generating, using the one or more door properties, a door movement operation executable by the robot to move the door.

### DESCRIPTION OF DRAWINGS

FIG. 1A is a perspective view of an example robot capable of performing door movement operations.

FIG. 1B is a schematic view of an example system of the robot of FIG. 1A.

FIG. 1C is a schematic view of an example system of the robot of FIG. 1A.

FIG. 2A is a schematic view of an example door movement system of the robot of FIG. 1A.

FIG. 2B is a schematic view of an example door movement system of the robot of FIG. 1A.

FIG. 2C is a schematic view of an example door movement system of the robot of FIG. 1A.

FIG. 2D is a schematic view of an example recovery manager for the door movement system of the robot of FIG. 1A.

FIG. 2E is a schematic view of an example door movement system of the robot of FIG. 1A.

FIG. 3A is a schematic view of an example door detection system operating in conjunction with a door movement system.

FIG. 3B is a schematic view of an example door detection system operating in conjunction with a door movement system.

FIG. 3C is a schematic view of an example door detection system operating in conjunction with a door movement system.

FIG. 3D is a schematic view of an example door detection system operating in conjunction with a door movement system.

FIG. 3E is a schematic view of an example door detection system operating in conjunction with a door movement system.

FIG. 4 is a schematic view of an example computing device that may be used to implement the systems and methods described herein.

Like reference symbols in the various drawings indicate like elements.

### DETAILED DESCRIPTION

As robots move about environments, robots may encounter structures (e.g., doors, hatches, windows, etc.). Robots may implement a particular operation or a set of operations (e.g., behaviors) to interact with the structure.

However, a robot may be limited to interacting with particular structures based on the programming of the robot. For example, a robot may not determine whether a door is heavy or light, whether a door automatically closes, how fast a door closes, and/or an amount of clearance to open the door. Therefore, the robot may be limited in how the robot interacts with structures. Further, the robot may not be able to autonomously explore particular buildings that include doors without human intervention. Instead, the robot may be limited to exploring buildings that do not include doors and/or may be limited to exploring buildings with human assistance and/or intervention.

Embodiments herein are directed toward systems and methods for interacting with particular structures in an environment of the robot. A navigation system of a robot enables the robot to receive sensor data associated with at least a portion of a structure. The robot can identify particular properties of the structure using the sensor data. For example, the robot can identify a size, a type, a width, an opening direction, etc. of the structure. Based on the identified properties, the robot can identify a structure operation (e.g., a door movement operation, such as door opening) and perform the structure operation. Therefore, the robot can gain additional navigation flexibility during runtime using the structure operations. Specifically, the robot can autonomously explore (e.g., for autonomous patrol missions) a building without human intervention. The robot can autonomously explore the building and open and/or close doors using the systems and methods described herein.

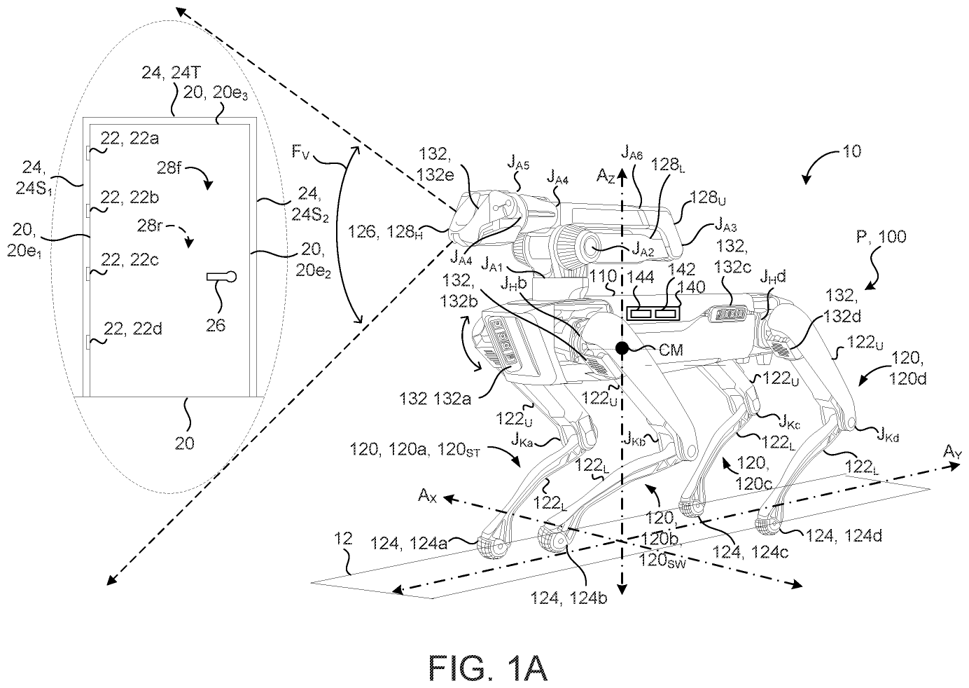

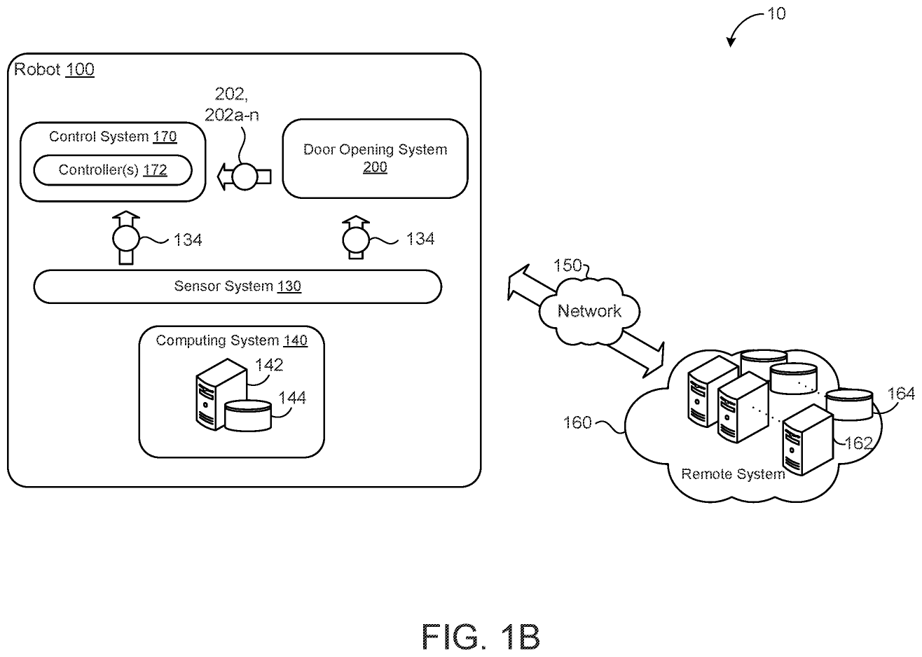

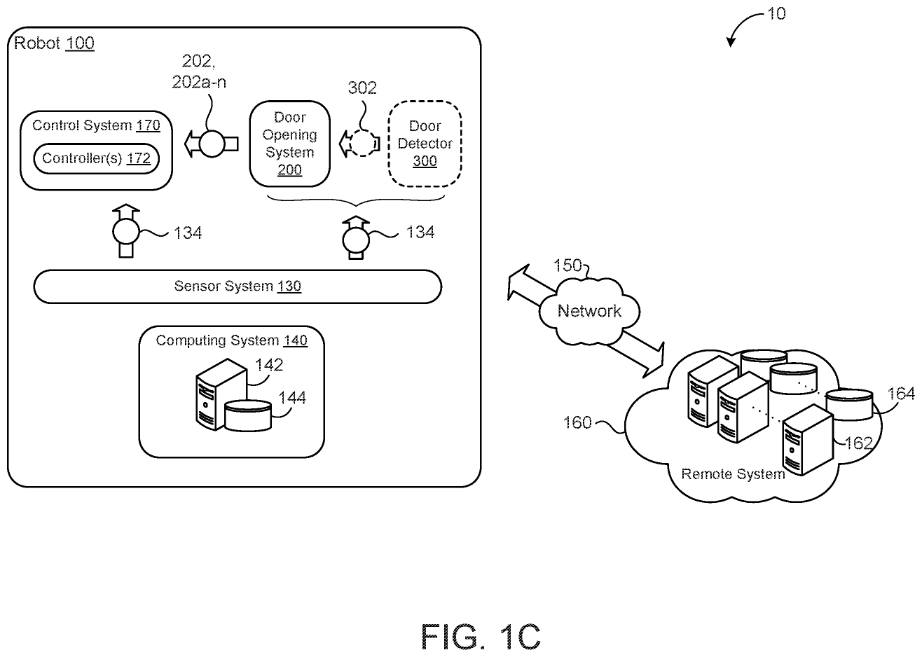

FIG. 1A is an example of an environment 10 for a robot 100. The environment 10 can refer to a spatial area associated with a terrain that includes a particular structure (e.g., door 20). For instance, FIG. 1A illustrates the door 20 in the field of view F_{V} of a sensor (e.g., sensor 132, 132e) mounted on the robot 100. As the robot 100 approaches the door 20, the robot 100 may engage in an operation or set of operations (e.g., behaviors) coordinated by the door movement system 200 (e.g., a door opening system). The door movement system 200 may use various systems of the robot 100 to interact with the door 20.

A door 20 can refer to a movable structure that provides a barrier between two adjoining spaces (for example, between two rooms). It will be understood that the door 20 can be any type of door. For example, the door 20 can move by either pivoting about one or more hinges 22 or by sliding along a track associated with the door 20. The door 20 may have a range of motion between a completely closed state where the door 20 is referred to as closed and a completely open state where the door 20 no longer occupies a frame 24 of the door 20 where the door 20 is referred to as opened. For a hinged door 20, one or more hinges 22 (e.g., shown in the illustrated embodiment as four hinges 22, 22a-d) coupled to the door 20 are also secured to a portion of the frame 24 (e.g., a side jamb). A frame 24 for a door 20 can include a head jamb 24, 24T (e.g., a top horizontal section spanning a width of the frame 24) and a side jamb 24, 24S_{1,2} on one or more sides of the door 20. All or a portion of the side jambs 24S can span a height of the door 20 and extend along a vertical edge 20, 20e_{1,2} of the door 20. When a door 20 pivots about its hinges 22 from the completely closed state to the completely open state, the door 20 may sweep a particular space (e.g., a swing area SA). If an object is located in the swing area SA, the door 20 may collide with the object as the door 20 pivots about its hinges 22 and swings through all or a portion of the range of motion.

A door 20 can include one or more door features (also referred to as features) to assist with moving the door 20 between the opened state and/or the closed state. In some configurations, the features include graspable hardware (e.g., a handle) mounted to a face (e.g., a surface) of the door 20 (e.g., the front surface 28f and/or the rear surface 28r opposite the front surface 280. Further, the feature may include a latching mechanism that allows the door 20 to latch to or to unlatch from the frame 24 of the door 20. Actuating the handle 26 (e.g., turning, rotating, or some other movement applied to the handle 26) may unlatch the door 20 from the frame 24 and allow the door 20 to open. Therefore, the latching mechanism may serve as a securement means for the door 20 such that the door 20 may be locked/unlocked or resist opening without purposeful actuation.

Referring to FIGS. 1A-1C, the robot 100 includes a body 110 with locomotion-based structures such as legs 120a-d coupled to the body 110 that enable the robot 100 to move about an environment 10 that surrounds the robot 100. In some examples, all or a portion of the legs 120 are an articulable structure such that one or more joints J permit members 122 of the leg 120 to move. For instance, in the illustrated embodiment, all or a portion of the legs 120 include a hip joint J_{H} coupling an upper member 122, 122_{U} of the leg 120 to the body 110 and a knee joint J_{K} coupling the upper member 122_{U} of the leg 120 to a lower member 122_{L} of the leg 120. Although FIG. 1A depicts a quadruped robot with four legs 120a-d, the robot 100 may include any number of legs or locomotive based structures (e.g., a biped or humanoid robot with two legs, or other arrangements of one or more legs) that provide a means to traverse the terrain within the environment 10.

In order to traverse the terrain, all or a portion of the legs 120 may have a distal end (e.g., a foot 124) that contacts a surface of the terrain (e.g., a traction surface). Further, the distal end of the leg 120 may be the end of the leg 120 used by the robot 100 to pivot, plant, or generally provide traction during movement of the robot 100. For example, the distal end of a leg 120 corresponds to a foot of the robot 100. In some examples, though not shown, the distal end of the leg includes an ankle joint such that the distal end is articulable with respect to the lower member of the leg.

In the examples shown, the robot 100 includes an arm 126 that functions as a robotic manipulator. The arm 126 may move about multiple degrees of freedom (e.g., six degrees of freedom plus the freedom of the hand member 128_{H}) to engage elements of the environment 10 (e.g., objects within the environment 10). In some implementations, the arm 126 connects to the robot 100 at a socket on the body 110 of the robot 100. In some configurations, the socket is configured as a connector such that the arm 126 may attach or detach from the robot 100. In one example, the arm 126 can include one or more members 128. The members 128 may be coupled by joints J such that the arm 126 may pivot or rotate about the joint(s) J. For instance, with more than one member 128, the arm 126 may extend or to retract. To illustrate an example, FIG. 1A depicts the arm 126 with three members 128 corresponding to a lower member 128_{L}, an upper member 128_{U}, and a hand member 128_{H} (also referred to as an end-effector). The lower member 128_{L} may rotate or pivot about one or more arm joints J_{A} located adjacent to the body 110 (e.g., where the arm 126 connects to the body 110 of the robot 100). For example, FIG. 1A depicts the arm 126 as able to rotate about a first arm joint J_{A1} or yaw arm joint. With a yaw arm joint, the arm 126 can rotate in 360 degrees (or some portion thereof, e.g., 330 degrees) axially about a vertical gravitational axis (e.g., shown as Az) of the robot 100. The lower member 128_{L} may pivot (e.g., while rotating) about a second arm joint J_{A2} (e.g., rotate about an axis extending in an x-direction axis Ax). For instance, the second arm joint J_{A2} can allow the arm 126 to pitch to a particular angle (e.g., raising or lowering one or more members 128 of the arm 126).

Additionally, the lower member 128_{L} may be coupled to the upper member 128_{U} at a third arm joint J_{A3}. The third arm joint J_{A1} may allow the upper member 128_{U} to move or to pivot relative to the lower member 128_{U} a particular degree of rotation (e.g., up to 180 degrees of rotation about an axis extending in the x-direction axis Ax). In some configurations, the ability of the arm 126 to pitch about the second arm joint J_{A2} and/or the third arm joint J_{A3} can enable the arm 126 to extend and/or to retract one or more members 128 of the arm 126 some length and/or distance. For example, FIG. 1A depicts the arm 126 with the upper member 128_{U} located (e.g., disposed) on or near the lower member 128_{L} such that the hand member 12811 extends some distance forward of the first arm joint J_{A1}. If both of the lower member 128_{L} and the upper member 128_{U} pitch about the second arm joint J_{A2} and the third arm joint J_{A3} respectively, the hand member 12811 may extend to a distance forward of the first arm joint J_{A1} that ranges from some length of the hand member 12811 (e.g., as shown) to about a combined length of each member 128 (e.g., the hand member 12811, the upper member 128_{U}, and the lower member 128_{L}).

In some implementations, the hand member 12811 is coupled to the upper member 128_{U} at a fourth arm joint J_{A4} that permits the hand member 12811 to pivot like a wrist joint in human anatomy. For example, the fourth arm joint J_{A4} enables the hand member 12811 to rotate about the vertical gravitational axis (e.g., shown as A_{Z}) some degree of rotation (e.g., up to 210 degrees of rotation). The hand member 128_{H} may also include another joint J that allows the hand member 128_{H} to swivel (e.g., also referred to as a twist joint) with respect to some other portion of the arm 126 (e.g., with respect to the upper member 128_{U}. Therefore, a fifth arm joint J_{A5} may allow the hand member 128_{H} to rotate about a longitudinal axis of the hand member 128_{H} (e.g., up to 330 degrees of twisting rotation).

In some implementations, the arm 126 includes a second twist joint depicted as a sixth joint J_{A6}. The sixth joint J_{A6} may be located at or near the coupling of the lower member 128_{L} to the upper member 128_{U}. The sixth joint J_{A6} may function to allow the upper member 128_{U} to twist or rotate relative to the lower member 128_{L}. Therefore, the sixth joint J_{A6} may function as a twist joint similarly to the fifth joint J_{A5} or wrist joint of the arm 126 adjacent the hand member 128_{H}. For instance, as a twist joint, one member coupled at a joint may move or rotate relative to another member coupled at the joint (e.g., a first member coupled at the twist joint is fixed while the second member coupled at the twist joint rotates).

In some examples, such as FIG. 1A, the hand member 128_{H} is a mechanical gripper that includes a one or more moveable jaws and/or fixed jaws that perform different types of grasping of elements within the environment 10. In the example shown, the hand member 128_{H} includes a fixed first jaw and a moveable second jaw that grasps objects by clamping the object between the jaws. The moveable jaw can move relative to the fixed jaw to move between an open position for the gripper and a closed position for the gripper (e.g., closed around an object).

The robot 100 can have a vertical gravitational axis (e.g., shown as a Z-direction axis A_{Z}) along a direction of gravity, and a center of mass CM. The CM may be a position that corresponds to an average position of all parts of the robot 100 where the parts are weighted according to their masses (e.g., a point where the weighted relative position of the distributed mass of the robot 100 sums to zero). The robot 100 further can have a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 may alter the pose P of the robot 100 (e.g., the combination of the position of the CM of the robot and the attitude or orientation of the robot 100). A height can refer to a distance along the z-direction (e.g., along a z-direction axis A_{Z}). The sagittal plane of the robot 100 may correspond to the Y-Z plane extending in directions of a y-direction axis A_{Y} and the z-direction axis A_{Z}. Therefore, the sagittal plane can bisect the robot 100 into a left and a right side. A ground plane of the robot 100 may be perpendicular to the sagittal plane and may span the X-Y plane by extending in directions of the x-direction axis A_{X} and the y-direction axis A_{Y}. The ground plane can refer to a ground surface 14 where distal ends (e.g., feet 124) of the legs 120 of the robot 100 may generate traction to help the robot 100 move about the environment 10. Another anatomical plane of the robot 100 can be the frontal plane that extends across the body 110 of the robot 100 (e.g., from a right side of the robot 100 with a first leg 120a to a left side of the robot 100 with a second leg 120b). The frontal plane spans the X-Z plane by extending in directions of the x-direction axis A_{X} and the z-direction axis A_{z}.

In order to maneuver about the environment 10 or to perform tasks using the arm 126, the robot 100 includes a sensor system 130 with one or more sensors 132, 132a-n. For instance, FIG. 1A illustrates a first sensor 132, 132a mounted at or near a head of the robot 100, a second sensor 132, 132b mounted at or near the hip of the second leg 120b of the robot 100, a third sensor 132, 132c mounted on a side of the body 110 of the robot 100, a fourth sensor 132, 132d mounted at or near the hip of the fourth leg 120d of the robot 100, and a fifth sensor 132, 132e mounted at or near the hand member 128_{H} of the arm 126 of the robot 100. The sensors 132 may include vision/image sensors, inertial sensors (e.g., an inertial measurement unit (IMU)), force sensors, kinematic sensors, or any other type of sensors. For example, the sensors 132 may include one or more of an image sensor (e.g., a camera, a stereo camera, etc.) a time-of-flight (TOF) sensor, a scanning light-detection and ranging (LIDAR) sensor, or a scanning laser-detection and ranging (LADAR) sensor. In some examples, one or more of the sensors 132 has a corresponding field(s) of view Fᵥ defining a sensing range or region corresponding to the sensor(s). For instance, FIG. 1A depicts a field of a view F_{V} for the first sensor 132, 132a of the robot 100. Each sensor 132 may be pivotable and/or rotatable such that the sensor 132 may, for example, change the field of view F_{V} about one or more axis (e.g., an x-axis, a y-axis, or a z-axis in relation to a ground plane).

When surveying a field of view F_{V} with a sensor 132 (see e.g., FIG. 1A), the sensor system 130 generates sensor data 134 (also referred to as image data) corresponding to the field of view F_{V}. The sensor system 130 may generate the field of view Fᵥ with a sensor 132 mounted on or near the body 110 of the robot 100 (e.g., sensor(s) 132a, 132b). The sensor system may additionally and/or alternatively generate the field of view Fᵥ with a sensor 132 mounted at or near the hand member 128_{H} (e.g., sensor(s) 132c). The one or more sensors 132 may capture sensor data 134 that defines the three-dimensional point cloud for the area within the environment 10 about the robot 100. In some examples, the sensor data 134 is image data that corresponds to a three-dimensional volumetric point cloud generated by a three-dimensional volumetric image sensor 132. Additionally or alternatively, when the robot 100 is maneuvering about the environment 10, the sensor system 130 gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg 120 or arm 126 of the robot 100. With the sensor data 134, various systems of the robot 100 may use the sensor data 134 to define a current state of the robot 100 (e.g., of the kinematics of the robot 100) and/or a current state of the environment 10 about the robot 100.

In some implementations, the sensor system 130 includes sensor(s) 132 coupled to a joint J. The sensors 132 may couple to a motor M that operates a joint J of the robot 100 (e.g., sensors 132, 132b-d). The sensors 132 may generate joint dynamics as joint-based sensor data 134. The joint-based sensor data 134 may include joint angles (e.g., an upper member 122_{U} relative to a lower member 122_{L} or hand member 12611 relative to another member of the arm 126 or robot 100), joint speed, joint angular velocity, joint angular acceleration, and/or forces experienced at a joint J (also referred to as joint forces). Joint-based sensor data generated by one or more sensors 132 may be raw sensor data, data that is further processed to form different types of joint dynamics, or some combination of both. For instance, a sensor 132 measures joint position (or a position of member(s) 122 coupled at a joint J) and systems of the robot 100 perform further processing to derive velocity and/or acceleration from the positional data. In other examples, a sensor 132 can measure velocity and/or acceleration directly.

As the sensor system 130 gathers sensor data 134, a computing system 140 can store, process, and/or communicate the sensor data 134 to various systems of the robot 100 (e.g., the computing system 140, the control system 170, and/or the door movement system 200). In order to perform computing tasks related to the sensor data 134, the computing system 140 of the robot 100 includes data processing hardware 142 and memory hardware 144. The data processing hardware 142 can execute instructions stored in the memory hardware 144 to perform computing tasks related to activities (e.g., movement and/or movement based activities) for the robot 100. The computing system 140 may refer to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., where a majority of centralized hardware and a minority of decentralized hardware). A decentralized computing system 140 may enable processing to occur at an activity location (e.g., at motor that moves a joint of a leg 120) while a centralized computing system 140 may allow for a central processing hub that communicates to systems located at various positions on the robot 100 (e.g., communicate to the motor that moves the joint of the leg 120).

Additionally or alternatively, the computing system 140 includes computing resources that are located remotely from the robot 100. For instance, the computing system 140 communicates via a network 180 with a remote system 160 (e.g., a remote server or a cloud-based environment). The remote system 160 may include remote computing resources, such as remote data processing hardware 162 and remote memory hardware 164. Sensor data 134 or other processed data (e.g., data processing locally by the computing system 140) may be stored in the remote system 160 and may be accessible to the computing system 140. In additional examples, the computing system 140 can utilize the remote resources 162, 164 as extensions of the computing resources 142, 144 such that resources of the computing system 140 may reside on resources of the remote system 160.

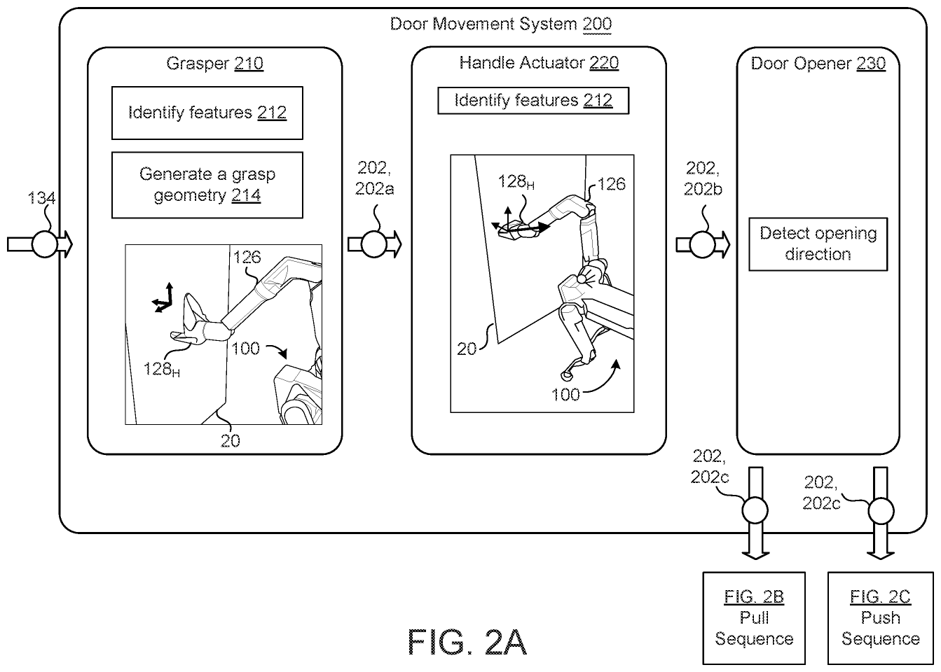

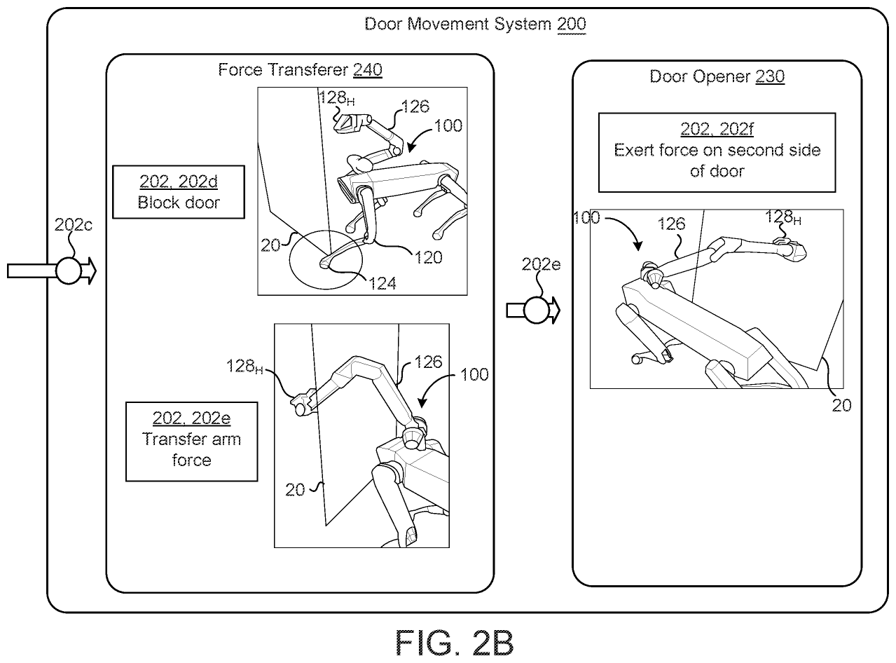

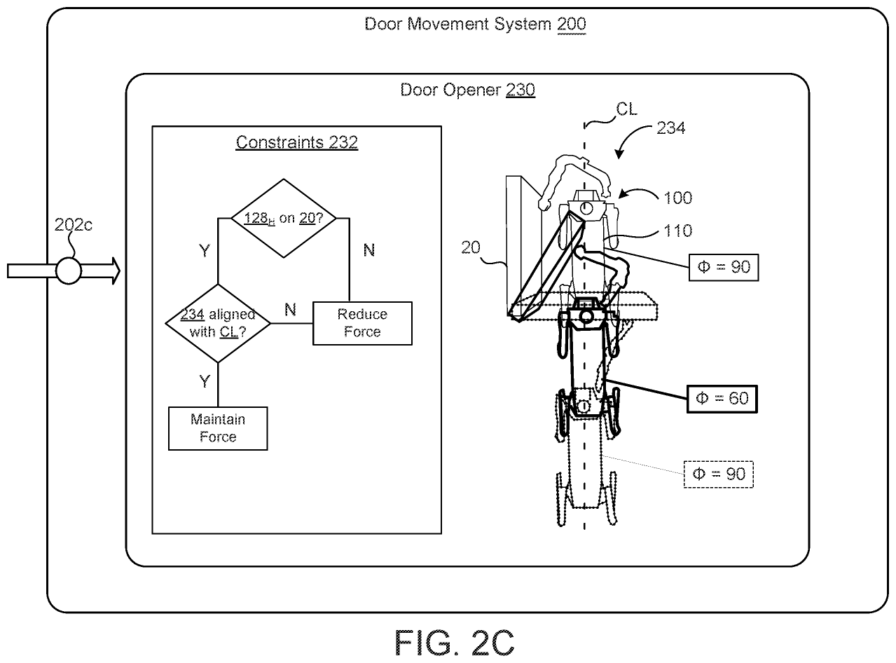

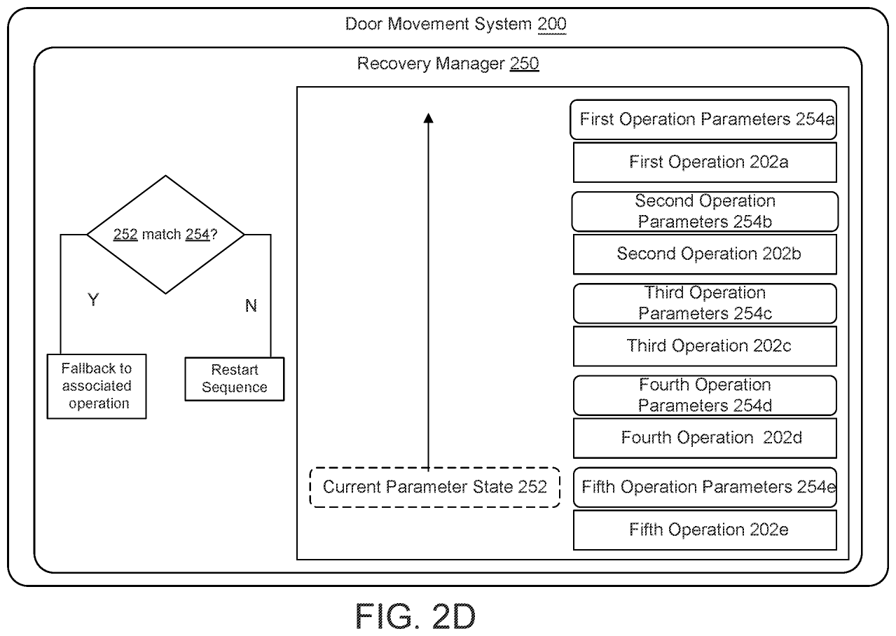

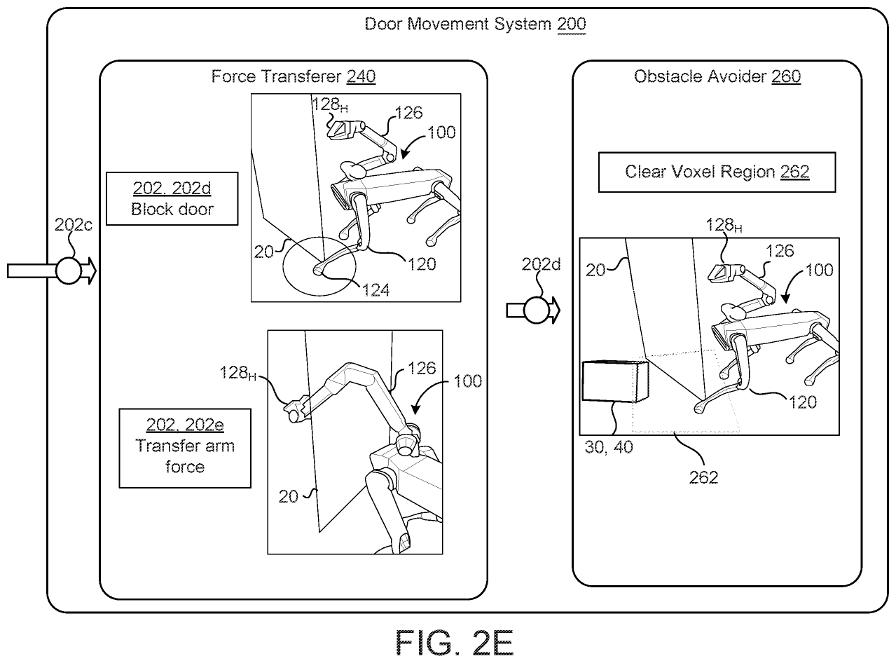

In some implementations, as shown in FIGS. 1B and 1C, the robot 100 includes a control system 170. The control system 170 may communicate with systems of the robot 100, such as the at least one sensor system 130 and the door movement system 200. As described in greater detail below with reference to FIGS. 2A-2D, the door movement system 200 may operate in conjunction with the control system 170 such that one or more controllers 172 receive, among a set of door movement operations (e.g., door opening and/or closing operations or actions) 202, 202a-n, each operation 202 or action from the door movement system 200 and control the robot to perform to perform the particular operation 202 (e.g., as shown in FIGS. 1B and 1C).

The control system 170 may perform operations and other functions using hardware such as the computing system 140. The control system 170 includes at least one controller 172 that can control the robot 100. For example, the controller 172 controls movement of the robot 100 to traverse about the environment 10 based on input or feedback from the systems of the robot 100 (e.g., the sensor system 130, the control system 170, and/or the door movement system 200). In additional examples, the controller 172 controls movement between poses and/or operations of the robot 100. At least one the controller 172 may be responsible for controlling movement of the arm 126 of the robot 100 in order for the arm 126 to perform various tasks using the hand member 128_{H}. For instance, at least one controller 172 controls the hand member 128_{H} (e.g., gripper) to manipulate an object or element (e.g., a door 20 or door feature (e.g., a handle 26)) in the environment 10. For example, the controller 172 actuates the movable jaw in a direction towards the fixed jaw to close the gripper. In other examples, the controller 172 actuates the movable jaw in a direction away from the fixed jaw to open the gripper.

In some examples, one or more controllers 172 responsible for controlling movement of the arm 126 may coordinate with the door movement system 200 in order to sense or to generate sensor data 134 when the robot 100 encounters a door 20. For instance, if the robot 100 determines (e.g., receives information identifying) a door 20 within the vicinity of the robot 100 (e.g., by an operator of the robot 100) or recognizes a door 20 within the vicinity, the controller 172 may manipulate the arm 126 to gather sensor data 134 about features of the door 20 (e.g., information about the feature (e.g., handle 26) of the door 20) and/or a current state of the door 20.

A given controller 172 may control the robot 100 by controlling movement about one or more joints J of the robot 100. In some configurations, the given controller 172 is software with programming logic that controls at least one joint J or a motor M which operates, or is coupled to, a joint J. For instance, the controller 172 controls an amount of force that is applied to a joint J (e.g., torque at a joint J). As programmable controllers 172, the number of joints J that a controller 172 controls is scalable and/or customizable for a particular control purpose. A controller 172 may control a single joint J (e.g., control a torque at a single joint J), multiple joints J, or actuation of one or more members 128 (e.g., actuation of the hand member 128_{H}) of the robot 100. By controlling one or more joints J, actuators or motors M, the controller 172 may coordinate movement for all different parts of the robot 100 (e.g., the body 110, one or more legs 120, the arm 126). For example, to perform some movements or tasks, a controller 172 may control movement of multiple parts of the robot 100 such as, for example, two legs 120a-b, four legs 120a-d, or two legs 120a-b combined with the arm 126.

Referring now to FIGS. 1B and 1C, the sensor system 130 of the robot 100 generates a three-dimensional point cloud of sensor data 134 for an area within the environment 10 about the robot 100. The sensor data 134 corresponds to the current field of view Fv of the one or more sensors 132 mounted on the robot 100. In some examples, the sensor system 130 generates the field of view Fv with the one or more sensors 132e mounted at or near the hand member 128_{H}. In other examples, the sensor system 130 additionally and/or alternatively generates the field of view Fv based on the one or more sensors 132a, 132b mounted at or near the body 110 of the robot 100. The sensor data 134 updates as the robot 100 maneuvers within the environment 10 and the one or more sensors 132 are subject to different field of views Fv. The sensor system 130 sends the sensor data 134 to the computing system 140, the control system 170, and/or the door movement system 200.

The door movement system 200 is a system of the robot 100 that communicates with the sensor system 130 and the control system 170 to specify operations for the robot 100 to open a door 20 in the environment 10 (also referred to as a sequence of door movement operations). In this sense, the door movement system 200 may refer to a sequence of actions or operations that coordinate the limbs (e.g., the legs 120 and/or the arm 126) and the body 110 of the robot 100 to open a door 20 and to traverse a space previously occupied by the door 20 while the door 20 is open. The door movement system 200 can receive sensor data 134 to locate the door 20 and/or features of the door 20 (e.g., the handle 26 of the door 20). The sensor data 134 (e.g., captured by one or more of the sensors 132) received by the door movement system 200 may correspond to proprioceptive sensor data 134 that enables the door movement system 200 to estimate a state of the door 20 (e.g., based on the impact that the door 20 is having on measurements internal to the robot 100). For instance, the sensor data 134 allows the door movement system 200 to generate a representation or model for the door 20 that the door movement system 200 may use to open the door 20. During the sequence of door movement operations, the door movement system 200 may also use sensor data 134 collected during the door movement sequence of operations to allow the arm 126 to intelligently engage with the door 20 throughout the door movement process. For example, the sensors 132 may provide force feedback for interactions that the robot 100 has with the door 20. More particularly, the sensor data 134 from the sensors 132 may inform the door movement system 200 as to force-based interactions with the door 20 such as actuating the handle 26 and pulling/pushing the door 20 to an open state (or closed state).

To provide an accurate account of the robot's forces and interactions with the door 20, the door movement system 200 may receive the sensor data 134 from one or more sensors 132 mounted on the hand member 128_{H} (e.g., directly mounted on the hand member 128_{H}). By receiving data 134 from sensors 132 mounted at or near the location of interaction with the door 20, the sensor data 134 may generally be more accurate as compared to data received away from the location of the interaction with the door 20. For instance, the door movement system 200 may process (e.g., interpret) the sensor data 134 from a sensor 132 of the hand member 128_{H} less as compared to sensor data 134 from a sensor 132 further from an interaction site between the robot 100 and the door 20. Although it may be more convenient to have sensors 132 generating sensor data 134 near or at the interaction site (e.g., a location where the robot 100 interacts with the door 20), the door movement system 200 may derive similar sensor information from sensors 132 located elsewhere on the robot 100 (e.g., located on the body 110 of the robot 100). For instance, the door movement system 200 may use sensor data 134 gathered by one or more sensors 132 mounted on the body 110 of the robot 100. Using sensors 132, such as these sensors 132 mounted on the body 110 of the robot 100, may include precise calibration of the sensors 132 relative to the arm 126 and/or hand member 128_{H} such that the kinematic relationships and dynamic variables accurately reflect the robot's interaction with the door 20. Direct sensing (e.g., generating sensor data 134 at the interaction site) as compared to the indirect sensing can be more accurate.

As the robot 100 navigates the environment 10, the robot 100 may not have any information regarding the presence of doors 20 within the environment 10. For example, the robot 100 may not have access and/or be aware of any a priori information regarding one or more doors 20 within the environment 10. Since the robot 100 may not have any information about the doors 20 that may be present in the environment 10, the door movement system 200 may identify a door 20 and subsequently interact with the door 20. In some examples, an operator or a user of the robot 100 may use a remote controller or some other means of communicating with the robot 100 to provide some type of indication that a door 20 is present in a particular vicinity about the robot 100. Further, a human operator of the robot 100 may provide a hint to the robot 100 that a door 20 exists in the spatial environment 10 about the robot 100. This hint, however, may not provide any further details about the door 20 or features of the door 20 (e.g., the hint may indicate that a door 20 exists/is present in the environment 10 and not indicate features of the door 20). Based on its own recognition or using a hint from an operator, the robot 100 may approach the door 20 in order to allow the door movement system 200 to learn information and/or features about the door 20. For example, the robot 100 can move to a position in order to stand in front of the door 20 and use the sensor(s) 132 associated with the robot's hand member 128_{H} (and/or other sensors 132 of the robot 100) to produce sensor data 130 for the door 20. In some examples, the robot 100 includes a sensor 132 (e.g., a TOF sensor 132 at the hand member 128_{H}) that generates three dimensional point cloud data for the door 20. With the sensor data 134 gathered by the robot 100 about the door 20, the door movement system 200 may identify features of the door 20.

In some implementations, the robot 100 may be provided with one or more maps that define the location of one or more doors 20 in a particular environment 10. For example, the robot 100 may receive a schematic of a building that defines the locations of doors 20 within the building and may integrate the information from the schematic into one or more navigational maps generated by the robot 100 (e.g., a mapping system or perception system of the robot 100). In other configurations, the robot 100 may be configured with image classification algorithms that receive sensor data 134 from the sensor system 130 of the robot 100 and classify one or more doors 20 that appear to be present in the environment 10 based on the data 134.

In some examples, the robot 100 configures its mapping systems for a particular environment 10 by performing a setup run of the environment 10. The robot 100 may drive or navigate through the environment 10 to perform the setup run. While navigating through the environment 10 on the setup run, the robot 100 may gather information that may be used to identify doors 20 within the environment 10. In some examples, an operator guides the robot 100 through this setup run. The operator may take the setup run as the opportunity to indicate to the robot 100 where doors 20 exist within the environment 10. In some examples, during the setup run, when the operator indicates that a door 20 is present in a particular location, the robot 100 may approach the door 20 and gather further information regarding the door 20. For instance, the robot 100 gathers three-dimensional sensor data 134 for the door 20 in order to define features of the door 20 such as door edges 20e, the handle 26 for the door 20, the door's spatial relationship to other nearby objects, etc. With this approach, when the robot 100 subsequently performs a mission or task in the environment 10 with a known door 20, the robot 100 may begin at a later operation in the door movement sequence that skips prior operation(s) that may gather information regarding the door 20.

Referring to FIGS. 2A-2D, the door movement system 200 generally includes a grasper 210, a handle actuator 220, a door opener 230, and a force transferor 240. These components 210, 220, 230, 240 of the door movement system 200 may collectively perform the sequence of operations that the robot 100 uses to open a door 20 within the environment 10. The sequence of operations may vary depending on whether the sequence corresponds to push door sequence or a pull door sequence. A push door sequence may correspond to a sequence where, to open the door 20, the robot 100 pushes the door 20 in a direction where the door 20 swings away from the robot 100. In contrast, a pull door sequence corresponds to a sequence where, to open the door 20, the robot 100 pulls the door 20 in a direction towards the robot 100 such that the door 20 swings towards the robot 100. Notably, some differences between these sequences are: (i) the initial direction of force that the arm 126 (e.g., the hand member 128_{H}) exerts on the handle 26 of the door 20 or the door 20 itself; and (ii) when the door 20 opens in a direction towards the robot 100, the robot 100 navigates around the door 20 to prevent the door 20 from colliding with robot 100. Whether the door 20 is configured for push sequence or a pull sequence may depend on how the door 20 can move (e.g., how the door 20 is mounted on the hinges 22) relative to the position of the robot 100 when the robot 100 encounters the door 20. For instance, a door 20 may swing from a first room into a second room to open. If the robot 100 approached the door 20 traveling from the first room to the second room, the robot 100 may implement a push sequence to open the door 20. If the robot 100 approached the door 20 traveling from the second room to the first room, the robot 100 may implement a pull sequence to open the door 20. To execute either sequence of operations, the door movement system 200 may include its own dedicated controllers 172 (e.g., one or more dedicated controller 172 to each component of the door movement system 200) or work in conjunction with the controller system 170 to use one or more controllers 172 capable of performing other non-door movement operations for the robot 100.

Each component 210, 220, 230, 240 of the door movement system 200 may perform one or more operations 202, 202a-n of a door movement sequence in order to progress the robot 100 through the entire sequence of operations that move the door 20. The door movement system 200 may operate in conjunction with the control system 170 such that one or more controllers 172 receive all or a portion of the operations 202 and control the particular operation 202 (e.g., as shown in FIGS. 1B and 1C). In some configurations, all or a portion of the components 210, 220, 230, 240 may be programmed to be its own feedback controller that coordinates and/or controls the operations 202 that it performs.

The grasper 210 can identify the door 20 within the environment 10 of the robot 100. In some examples, the grasper 210 identifies the door 20 based on sensor data 134. In some configurations, the grasper 210 receives sensor data 134 that corresponds to a three-dimensional point cloud of the door 20 and, based on the sensor data 134, the grasper 210 identifies features of the door 20 and/or models a current state of the door 20. In some implementations, the door movement system 200 receives an indication that a door 20 (e.g., from an operator of the robot 100, from an image classifying system of the robot, and/or from a perception/mapping system of the robot 100) is located at a particular location within the environment 10. Upon receiving the indication, the robot 100 may move and/or reposition itself in a door movement stance position (e.g., a door opening stance position) in front of the door 20. In the door movement stance position, the sensors 132 of the robot 100 can provide a field of view F_{V} of the door 20 that the sensors 132 capture and relay to the door movement system 200. The robot 100 may gather the sensor data 134 for the door 20 by moving around in the vicinity adjacent to the door 20.

In some examples, the robot 100 gathers sensor data 134 for the door 20 by modifying an orientation of the body 110 of the robot 100 (e.g., by pitching the body 110, rolling the body 110, and/or yawing the body 110). Additionally or alternatively, the arm 126 of the robot 100 includes sensor(s) 132 (e.g., TOF sensor(s)) such that the robot 100 may scan the location that the door movement system 200 receives as the indication for where the door 20 is located within the environment 10. For example, by using the arm 126 as a means of sensing, the door movement system 200 may receive fine-grained sensor data 134 that may more accurately estimate the location of features 212 of the door 20.

Based on the sensor data 134 corresponding to the door 20, the grasper 210 identifies features 212 of the door 20. For example, the features 212 of the door 20 may include the handle 26 of the door 20, one or more edges 20e of the door 20, the hinges 22 of the door 20, or other characteristics common to a door 20. From the identified features 212, the grasper 210 can obtain spatial understanding of the spatial location of the handle 26 of the door 20 relative to the robot 100 and/or the door 20. Further, from the sensor data 134, the grasper 210 can determine the location of the handle 26 of the door 20. In some examples, since the sensor data 134 corresponds to a three-dimensional point cloud data, the grasper 210 can determine a geometry or shape of the handle 26 to generate a grasp geometry 214 for the handle 26 of the door 20. The grasp geometry 214 can refer to a geometry of an object used to plan a grasping pose for a hand member 128_{H} to engage with the object. For example, the object may be the handle 26 of the door 20 to enable the door movement process to proceed along the sequence of operations 202. Using the grasp geometry 214, the grasper 210 can generate a first operation 202, 202a for the hand member 128_{H} of the arm 126. The first operation 202a can control the hand member 128_{H} of the arm 126 to grasp the handle 26 of the door 20. For example, the grasper 210 controls the arm 126 (e.g., robotic manipulator) of the robot 100 to grasp the handle 26 of the door 20 on a first side of the door 20 that faces the robot 100.

With the handle 26 grasped by the hand member 128_{H} of the arm 126, the door movement system 200 continues the door movement sequence by communicating the execution of the first operation 202a to the handle actuator 220. The handle actuator 220 can perform a second operation 202, 202b to actuate the handle 26 of the door 20. The type and/or amount of actuation for the handle 26 may vary depending on the type of handle 26 that the door 20 has. For instance, the handle 26 may be a lever handle, a doorknob, a handle set, or other known construction for a door handle 26. Further, actuation of the handle 26 may refer to twisting/turning of the handle 26 a particular degree of rotation. By turning the handle 26 a particular degree of rotation, the second operation 202b may enable the handle 26 to unlatch the door 20 from the frame 24 such that the latching mechanism of the door 20 may not prevent or inhibit the robot 100 from successfully opening the door 20. Some handles 26 may unlatch the door 20 from the frame 24 when actuated in either direction. Other handles 26 may unlatch the door 20 from the frame 24 when actuated in a particular direction (e.g., rotated in one direction rather than another direction). The handle actuator 220 may determine which direction to rotate the handle 26 in order to unlatch the door 20 from the frame 24 and successfully actuate the handle 26 to perform the second operation 202b.

When the hand member 128_{H} of the arm 126 successfully actuates the handle 26 unlatching the door 20 from the frame 24, the door movement system 200 can continue the door movement sequence by communicating the execution of the second operation 202b to the door opener 230. The door opener 230 may perform more than one operation 202 in the door movement sequence. When the door opener 230 receives an indication that the handle actuator 220 has executed the second operation 202b, the door opener 230 may identify which direction the door 20 will open. That is, the door opener 230 can perform a third operation 202, 202c to detect whether the door 20 opens by swinging in a first direction towards the robot 100 or a second direction away from the robot 100.

In some implementations, to detect which direction the door 20 opens, the door opener 230 can test each opening direction for the door 20 by exerting a pull force on the handle 26 and/or exerting a push force on the handle 26. When the door opener 230 senses less resistance in a particular direction, the door opener 230 can determine that the direction with less resistance (e.g., compared to the other direction) corresponds to a swing direction for the door 20. In some examples, in order to sense which direction has less resistance, when the door opener 230 exerts a force in that direction, the door opener 230 uses sensor data 134 generated by the sensor system 130 while the door opener 230 exerts the door movement test force in a particular direction. The sensors 132 used by the door opener 230 to determine the direction in which the door 20 opens may be proprioceptive sensors that measure values internal of the robot 100, exteroceptive sensors that gather information external to the robot 100 (e.g., about the robot's relationship to the environment 10), or some combination of both. For example, sensor data 134 from proprioceptive sensors may inform the door opener 230 as to whether a load on one or more actuators of the robot 100 increases or decreases as the door opener 230 exerts a pull force and/or a push force while testing the opening direction of the door 20. The door opener 230 may expect the initial force exerted on the door 20 in the opening direction to be a first magnitude and then to remain constant or to decrease when the door opener 230 is exerting the force in a direction that matches the opening direction for the door 20. In contrast, the door opener 230 may expect the initial force exerted on the door 20 in a direction opposite the opening direction to be a first magnitude and then to increase when the door opener 230 is exerting the force against the opening direction for the door 20. As shown in FIG. 2A, when the door opener 230 executes the third operation 202c and determines the door movement direction, the door movement system 200 proceeds to either a pull door sequence (e.g., FIG. 2B) or a push door sequence (e.g., FIG. 2C).

Referring to FIG. 2B, after the door opener 230 executes the third operation 202c and identifies that the door 20 opens in a direction towards the robot 100, the door movement system 200 transitions to a pull sequence to open the door 20. As the door opener 230 initially pulls the door 20 open towards the robot 100, the door 20 can swing from a completely or relatively closed state to a partially open state (e.g., between 20 to 40 degrees partially open from the closed state). The completely closed state (also referred to as a closed state) for the door 20 can occur when the door 20 is aligned or coplanar with the walls that transition to the frame 24 of the door 20. Further, the door 20 may be completely closed when the volume of the door 20 occupies an entirety of the frame 24 of the door 20 (e.g., the edges 20e of the door 20 abut the frame 24). In contrast, the door 20 is in a completely open state (also referred to the open state) when the door 20 is perpendicular to a plane spanning the frame 24 of the door 20. Accordingly, the door 20 may swing to any degree between the closed state and the open state such that the swing area SA for the door 20 spans at least a 90 degree arc corresponding to the width of the door 20.

When the pull force that is opening the door 20 pulls the door 20 partially open, the force transferor 240 can perform a fourth operation 202, 202d that blocks/chaulks the door 20 from closing. By blocking/chaulking the door 20 from closing, the robot 100 may reconfigure the manner in which the robot 100 is opening the door 20 and allow the robot 100 to avoid a collision with the door 20 as the door 20 swings toward the open state. For example, if the robot 100 remains at or near its opening stance position, the robot 100 may be at least partially located in the swing area SA of the door 20 and may interfere with the opening of the door 20. By blocking the door 20 from closing, the fourth operation 202d may therefore allow the robot 100 to transfer the force being exerted by the arm 126 to open the door 20 from a pull force to a push force and to move around (e.g., to step around) the door 20 as the arm 126 then pushes the door 20 further open.

In some examples, the robot 100 can use one of the feet 124 to block the door 20. For instance, as shown in FIG. 2B, the robot 100 blocks the door 20 with the front foot 124 of the robot 100 that the door 20 encounters first as the door 20 swings open. Specifically, the robot 100 chaulks the door 20 with the foot 124 closest to the edge 20e of the door 20 opposite the hinges 22 to maintain the door 20 partially open.

In some implementations, the door movement system 200 collaborates with a perception system of the robot 100 in order to identify the edge 20e of the door 20 for the blocking operation 202d. The perception system of the robot 100 may receive sensor data 134 (e.g., as the door 20 opens). The perception system may generate a voxel map for an area about the robot 100 that includes the door 20 and, more particularly, the edge 20e of the door 20 using the sensor data 134. Since the voxel map, or derivative forms of the voxel map, may identify obstacles about the robot 100 in real-time or near real-time, the perception system may recognize the edge 20e of the door 20 as the edge of a moving obstacle adjacent to the robot 100 (e.g., an obstacle located at the hand member 128_{H} of the arm 126). Therefore, the force transferor 240 of the door movement system 200 may use obstacle information from the perception system to more accurately detect the edge 20e of the door 20 for the blocking operation 202d than using the sensor data 134 without being processed by the perception system. Using the information from the perception system to identify the edge 20e of the door 20, the force transferor 240 can block the door 20 by instructing the robot 100 to move the foot 124 of the robot 100 nearest the edge 20e of the door 20 to a position where the inside of that foot 124 contacts or is adjacent to the outside portion of the identified edge 20e for the door 20. For instance, if the door 20 swings open towards the robot 100 from the left side of the robot 100 to the right side of the robot 100 (e.g., the door 20 is left-handed), the left front foot 124 of the robot 100 may block the door 20 since the edge 20e of the door 20 first encounters the left front foot 124 when swinging open. In contrast, if the door 20 swings open towards the robot 100 from the right side of the robot 100 to the left side of the robot 100 (e.g., the door 20 is right-handed), the right front foot 124 of the robot 100 may block the door 20 since the edge 20e of the door 20 first encounters the right front foot 124 when swinging open.

With the foot 124 blocking the door 20 from closing, the force transferor 240 may perform a fifth operations 202e that releases the door 20 at the hand member 128_{H}; allowing the door 20 to potentially swing towards the closed state and contact the blocking foot 124 of the robot 100. As illustrated in the example of FIG. 2B, with the hand member 128_{H} no longer exerting the pull force on the first side of the door 20 that initially pulled open the door 20, the arm 126 of the robot 100 may hook or wrap around the door 20 and exert a force on the second side of the door 20 opposite the first side of the door 20 that continues to move the door 20 to the open state. In addition to blocking the door 20 with the foot 124, by transferring force to the second side of the door 20, the robot 100 may hook the arm 126 around the door 20 such that at least a portion of the arm 126 contacts the edge 20e of the door 20 being blocked by the foot 124 and also a portion of the arm 126 contacts the second side of the door 20. For example, as illustrated by FIG. 1A, the arm 126 may include multiple arm joints J_{A} that allow the arm 126 to articulate in different ways.

To hook the door 20 as the arm 126 transfers the door movement force (e.g., a door opening force) from the first side of the door 20 to the second side of the door 20, the fourth arm joint J_{A4} may articulate such that the hand member 128_{H} extends along the second side of the door 20 and the upper member 128_{U} of the arm 126 extends along the edge 20e of the door 20 (e.g., forming an L or hook that contours the intersection of the second side of the door 20 and the edge 20e of the door 20). With this hook configuration, the arm 126 may initially pull the door 20 further open while stepping around the door 20 until the arm 126 can push the door 20 away from the robot 100 with the door movement force. By hooking the door 20, the arm 126 may have leverage to shift from exerting the door movement force as a pull force to a push force in order to continue opening the door 20 for the robot 100. Additionally or alternatively, more than one arm joint J_{A} can enable the arm 126 to hook the door 20. For instance, the sixth joint J_{A6}, as a twist joint, may twist or rotate the upper member 128_{U} about its longitudinal axis such that the rotation allows the fourth joint J_{A4} and/or fifth joint J_{A5} at or near the hand member 128_{H} to rotate and hook the door 20. Therefore, an arm joint J_{A} (e.g., the sixth arm joint J_{A6}) can operate to turn the hand member 12811 in a manner that allows the hand member 128_{H} to yaw instead of pitch to hook the door 20.

With continued reference to FIG. 2B, the door movement system 200 communicates the execution of the fifth operation 202e to the door opener 230 to allow the door opener 230 to perform a sixth operation 202, 202f that continues to exert the door movement force on the door 20 to swing the door 20 open. When the door opener 230 receives the communication corresponding to the execution of the fifth operation 202e, the door opener 230 may determine the opening of the door 20 may not pose a collision risk with the robot 100 since the robot 100 has stepped around the door 20. At this point, the door opener 230 may exert a door movement force that prevents the door 20 from closing to collide with the robot 100 as the robot 100 traverses the open doorway previously occupied by the door 20. In some configurations, the arm 126 continues to exert the door movement force on the door 20 until the door 20 no longer poses a threat to collide with a rear portion of the body 110 of the robot 100 or one or more rear legs 120 of the robot 100. In some examples, a length of the arm 126 dictates when the arm 126 decreases the amount of force being exerted on the second side of the door 20 since the arm 126 may not be long enough to hold the door 20 open until the robot 100 traverses (e.g., completely traverses) the doorway. In some implementations, the arm 126 may reduce the amount of force being exerted on the second side of the door 20, but still function as a block to prevent the door 20 from swinging closed and hitting the robot 100 at a location other than the arm 126.

Referring to FIGS. 2A and 2C, after the door opener 230 executes the third operation 202c and identifies that the door 20 opens in a direction away from the robot 100, the door movement system 200 transitions to a push sequence to open the door 20. During the push sequence, the door movement system 200 may not need transfer the door movement force from the first side of the door 20 to the second side of the door 20. Rather, to open the door 20, the door opener 230 may proceed to exert the door movement force on the first side of the door 20 in order to push the door 20 along its swing path to the open state.

When executing a push sequence, the robot 100 may begin to traverse the doorway as the door 20 opens. In some examples, as the robot 100 traverses the doorway, the door opener 230 may control the movement of the robot 100 or collaborate with the control system 170 to coordinate the movement of the robot 100. In order to achieve coordinated actions between the movement of the robot 100 through the doorway and the opening of the door 20, the door opener 230 can operate with at least one operational constraint 232. In some examples, the operational constraints 232 may be that the door opener 230 (i) continues to push the door 20 open while (ii) maintaining the arm 126 (e.g., the hand member 128_{H}) in contact with the first side of the door 20 (e.g., with the door handle 26), and (iii) maintaining a goal position 234 for the body 110 of the robot 100. The goal position 234 can refer to a constraint 232. The door opener 230 may attempt to keep the body 110 of the robot (e.g., the center of mass COM of the robot 100) aligned along a centerline CL of the door frame 24 as the robot 100 traverses the doorway. Therefore, the door opener 230 can aim to maintain a body alignment position along the centerline CL of the door frame 24.

By incorporating the constraint 232, the door opener 230 may manage the door movement force as a function of the door angle. Specifically, since the robot 100 intends to walk through the doorway at some forward velocity, the door opener 230 may control the swing speed of the door 20 to be a function of the forward velocity of the robot 100. For instance, the operator of the robot 100 or autonomous navigation system of the robot 100 may have a desired traversal speed across the doorway. The desired door angle may become a function of the robot's progress through the door 20 (e.g., along the centerline CL) at the desired speed of travel. Further, the door movement force exerted by the hand member 128_{H} is managed by the door opener 230 by determining a deviation or error between the actual door angle and the desired door angle for the robot's speed.

In some examples, by maintaining the body alignment position 234 along the centerline, the door opener 230 can reduce a forward traveling velocity of the COM of the robot 100 if the actual position of the COM of the robot 100 deviates from the goal position 234 (e.g., position along the centerline CL). FIG. 2C illustrates the body alignment position 234 of the robot 100 along the centerline CL as a function of the door angle by depicting a time sequence where the door 20 is initially closed (e.g., shown at 0 degrees), partially open (e.g., shown at 60 degrees), and fully open (e.g., shown at 90 degrees). With constraints 232 for the door opener 230, the door movement system 200 enables the robot 100 to traverse the doorway at a gait with a traversal speed proportion to the opening force being exerted on the first side of the door 20. For example, door opener 230 exerts a door movement force that maintains a door 20 swing speed for the door 20 that is equal to the traversal speed of the robot 100.

In some implementations, such as FIG. 2D, the door movement system 200 can include a recovery manager 250. The recovery manager 250 can coordinate recovery and fallback operations 202 (e.g., when the robot 100 is disturbed during a door movement sequence). With the recovery manager 250, the door movement system 200 can prevent the robot 100 from having to restart the door movement sequence to open a door 20. Further, if the arm 126 was disturbed such that the disturbance knocked the arm 126 off of the door 20 while the arm 126 was performing the sixth operation 202f pushing the door 20 open during a pull sequence, the recovery manager 250 may monitor the state (e.g., the current state) of the operations 202 and instruct the robot 100 to block the door 20 with its foot 124 before the door 20 completely closes due to a lack of force by the robot 100.

To execute one or more fallback operations 202, the recover manager 250 may identify a current parameter state 252 based on determining a disturbance occurs and compare this current parameter state 252 to operation parameters 254a-n (e.g., first operation parameters 254a, second operation parameters 254b, third operation parameters 254c, fourth operation parameters 254d, fifth operation parameters 254e, etc.) that are associated with the operations 202a-n performed by the components 210, 220, 230, 240 of the door movement system 200. The recovery manager 250 may cycle through each operation 202 to identify whether the current parameter state 252 matches parameters 254 associated with a particular operation 202. Upon identifying a match, the door movement system 200 may not restart the door movement sequence, but rather may fall back to perform the operation 202 associated with the matching parameters 254. Therefore, the recovery manager 250 may treat each operation 202 as its own domain or sub-sequence where each operation 202 begins with a particular set of parameters 254 that enable that operation 202 to occur.

Accordingly, when the door movement system 200 executes a particular operation 202, the door movement system 200 can output operation parameters 254 that enable the next operation 202 in the door movement sequence to occur. Therefore, if the recovery manager 250 identifies that the current parameter state of the robot 100 resulting from the disturbance matches operation parameters 254 that enable an operation 202 to occur, the recovery manager 250 may instruct the robot 100 to continue the door movement sequence at that operation 202. This technique may allow the recovery manager 250 to take a top down approach where the recover manager 250 attempts to recover the door movement sequence at an operation 202 near completion of the door movement sequence and work backwards through the operations 202 to an initial operation 202 that begins the door movement sequence. For example, FIG. 2D illustrates the recovery manager 250 performing the operation recovery process by initially determining whether the fifth operation parameters 254e match the current parameter state 252.

In some configurations, the door movement system 200 operates while other various systems of the robot 100 are also performing. One such example of this parallel operation is that the door movement sequence may be performed in more complicated areas such as when a door 20 occurs at the top of a staircase landing. In this situation, the initial opening stance position of the robot 100 may not include all feet 124 of the robot 100 being in contact with the same ground plane, but rather the feet 124 of the robot 100 may be in contact with ground planes at different heights. For instance, when the door 20 is located at the top of the stairs, a size of the robot 100 (e.g., length of the body 110 of the robot 100) may prohibit the robot 100 from standing with all four legs 120 on the same ground plane. Instead, one or more legs 120 (e.g., the rear or hind legs) may be located at a lower elevation (e.g., on a lower stair) than the other legs 120 (e.g., the front legs). Traversing the swing area SA to walk through the door 20 may include one or more of the legs 120 traversing the elevated terrain of the remaining stairs. Since a perception system or navigational system of the robot 100 may be operating while the door movement sequence occurs, the robot's other systems may navigate the legs 120 to traverse the remainder of the steps while the robot 100 opens the door 20 and walks through the doorway.

In some configurations, the door movement system 200 includes or is coordinating with an obstacle avoider 260 during the door movement sequence. An obstacle avoider 260 can enable the robot 100 to recognize and/or avoid obstacles 30 that may be present in an area around the door 20 (e.g., in the swing area SA). Furthermore, the obstacle avoider 260 may integrate with the functionality of the door movement system 200. As previously stated, the door movement system 200 may be operating in conjunction with a perception system or a mapping system of the robot 100. The perception system may generate one or more voxel maps for an area about the robot 100 (e.g., a three meter near-field area). A voxel map generated by the perception system may be generated from sensor data 134 and from some version of an occupancy grid that classifies or categorizes two or three-dimensional cells of the grid with various characteristics. For example, each cell may have an associated height, a classification (e.g., above-ground obstacle (e.g., a chair), below-ground obstacle (e.g., a hole or trench), a traversable obstacle (e.g., has a height that the robot 100 can step over), etc.), or other characteristics defined at least in some manner based on sensor data 134 collected by the robot 100.

When the door movement system 200 operates in conjunction with the perception system, this integration may be coordinated by way of the obstacle avoider 260. For instance, the obstacle avoider 260 may allow the door movement system 200 to recognize the edge 20e of the door 20 as the door 20 is moving (e.g., opening) by detecting the door 20 as occupying some space (e.g., some set of cells) in a voxel-based map. In this respect, as the door 20 moves, the perception system perceives that new cells are being occupied (e.g., cells where the door 20 has swung into) and previously occupied cells are becoming unoccupied (e.g., the door 20 has swung to a position that no longer occupies those cells). Since the obstacle avoider 260 is integrated with the door movement system 200, the obstacle avoider 260 may recognize that the cells are changing states in response to operations 202 being executed by the door movement system 200 (e.g., opening the door 20).

In some implementations, the obstacle avoider 260 leverages the knowledge of the operations 202 executed (e.g., currently being executed) by the door movement system 200 to detect obstacles 30 such as blind obstacles or door-obstructed obstacles. Further, the robot 100 may encounter an obstacle 30 on the other side of the door 20 that was not perceivable by the robot 100 when the door 20 was closed or partially closed obstructing the robot's view of the obstacle 30. An obstacle 30 that the robot 100 is unable to perceive at some stage of the door movement sequence that may inhibit the robot's ability to successfully traverse the door 20 and doorway may be considered a blind obstacle. For instance, the door 20 may be a basement door and the robot 100 may be traveling from the basement to a first level. A chair from a kitchen table may be partially obstructing the doorway, but the robot 100 may be unable to see this obstacle 30 because the obstacle 30 is on the other side of the closed basement door (e.g., the robot's sensor field of view is obstructed by the door 20). A perception system (e.g., a voxel-based system) can identify cell occupancy in real-time or near real-time for the robot 100, however, the fact that door 20 will be moving and the chair is near the door 20 may cause additional challenges. Therefore, the occupancy grid may appear to have several occupied cells and cells changing occupied/unoccupied status causing a perception system to potentially perceive that more obstacles 30 exist within a field of view (e.g., akin to perception noise).

To overcome this issue, the obstacle avoider 260 can leverage its knowledge of the operations 202 currently being executed by the door movement system 200 to enhance its ability to classify non-door objects 40. For instance, the obstacle avoider 260 clears the voxel region 262 of a voxel map around where it knows the door 20 (e.g., based on the operations 202) to be located. As shown in FIG. 2E, the obstacle avoider 260 may receive an indication that the door movement system 200 has blocked the door 20 (e.g., the fourth operation 202d) and, in response to this indication, the obstacle avoider 260 may clear a voxel region 262 of a voxel map in an area around the door 20. FIG. 2E shows the obstacle avoider 260 clearing the voxel region 262 in response to the blocking operation 202d, however, the obstacle avoider 260 may clear the voxel region 262 about the robot 100 at one or more other stages of the door movement sequence. By clearing the voxel region 262 about the door 20, the obstacle avoider 260 can focus on non-door objects 40 (e.g., such as the box 40 shown in FIG. 2E) that may be present in the perception field of the robot 100 and/or to determine whether these non-door objects 40 pose an issue for the robot 100 (e.g., are obstacles 30 that need to be avoided). In addition to focusing the obstacle avoider 260 on non-door objects 40 that may be obstacles 30, clearing the voxel region 262 about the door 20 may also enable the perception system to avoid declaring or communicating that the door 20 itself is an obstacle 30 while the door movement system 200 is performing operations 202 to account for or avoid the door 20. In this respect, the obstacle avoider 260 working with the door movement system 200 can prevent a perception system or some other obstacle aware system from introducing other operations or operation recommendations that may compromise the success of the door movement sequence. Otherwise, the robot 100 may be afraid of hitting the door 20 in the sense that other built-in obstacle avoidance systems are communicating to the robot 100 that the door 20 is an obstacle 30 that should be avoided.

Referring back to FIG. 1C, the robot 100 may include or be in communication with a door detector 300. The door detector 300 can receive sensor data 134 capturing a door 20 within the environment 10 of the robot 100 and determine one or more predicted door properties 302 characterizing an initial state 304 of the door 20. The door detector 300 is shown in a dotted outline to indicate that the door detector 300 may be integrated with systems located on the robot 100 itself or in remote communication with the systems of the robot 100 (e.g., in remote communication with the door movement system 200). As discussed previously, the door movement system 200 may identify features 212 of a door 20 from sensor data 134. The door detector 300 can provide the features 212 (e.g., as predicted door properties 302) to components 210, 220, 230, 240 of the door movement system 200. Furthermore, employing a door detector 300 allows the door movement system 200 to identify a door 20 and/or its features 212 without operator inputs. With a door detector 300, the sensor data 134 gathered by the robot 100 may be interpreted in order to generate predicted properties 302 of the door 20 that then may be used downstream at the various components 210, 220, 230, 240 of the door movement system 200. In this respect, the door detector 300 functions as a door identification system for the robot 100. Therefore, with the door detector 300 and the door movement system 200, the robot 100 may operate autonomously or semi-autonomously to perform tasks or missions within the environment 10 that encounter one or more doors 20. For example, the robot 100 may perform autonomous or semi-autonomous patrol missions, and during the patrol mission, automatically (e.g., without human intervention) detect a status (e.g., opened, closed, partially open, etc.) of a door 20 and respond appropriately (e.g., open the door 20, close the door 20, etc.) as defined by the mission parameters.

A door 20 may have features 212 that affect the properties of a door 20. Features 212 may refer to components of the door 20 itself (e.g., structural components). Some examples of features 212 include door frames 24, door hinges 22, door handles 26 (e.g., door knobs), door pushbars, etc. The configuration of one or more of the features 212 can impact or define properties of the door 20, such as door measurements (e.g., door width, door height, location of the door handle/pushbar), door swing direction, door handedness, etc. Further, the properties of the door 20 can affect the successfulness of a door movement sequence. For instance, if the location of the door handle 26 is inaccurate, the handler 210 may fail to grasp the door handle 26 successfully to initiate the door movement sequence. In another example, the width of the door 20 may determine whether the robot 100 blocks the door 20 successfully or pushes the door 20 at a location that enables the robot 100 to successfully traverse through an open door 20. Therefore, accurate door properties may result in the door movement system 200 having a greater likelihood of success. Additionally, although some door properties can be assumed from general door form factors and/or building code, relying on these assumptions alone can also impact the successfulness of the door movement sequence. For example, the robot 100 may encounter a door, but with a custom or unique door handle and have difficulty grasping the custom handle.

Because door movement operations 202 interact with a door 20 in different manners, the door properties can inform the door movement system 200 how to perform a particular door movement operation 202. By generating one or more predicted door properties 302, the door detector 300 enables the door movement system 200 to perform operations 202 catered to the specifics of a door 20 that the robot 100 encounters. Additionally, predicted door properties 302 for a door 20 at a particular point in time define or characterize a current state 304 of the door 20. By using sensor data (e.g., current sensor data 134) to generate the predicted door properties 302, the door detector 300 allows the door movement system 200 to open the door 20 starting from the state 304 (e.g., the current state 304). In contrast, some door movement operations rely on the door movement operation starting from the door 20 being closed (e.g., a closed door state as a current state). When a door movement operation starts from a closed door state, the robot 100 may fail to successfully navigate or traverse through a door 20 that the robot 100 encounters in a state other than a closed door state. For instance if the door 20 is partially ajar, but not open enough for the robot 100 to fit through, a door movement operation that starts from a closed door state may incorrectly assume that the ajar door 20 is in a closed state and perform sub-optimal door movement operations based on an incorrect state of the door 20 (e.g., potentially compromising the robot's ability to successfully navigate the door 20).

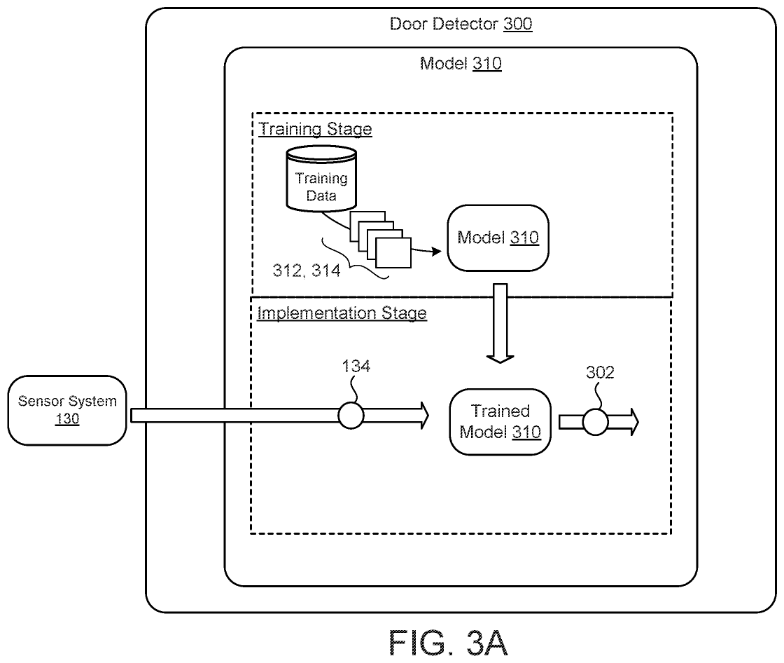

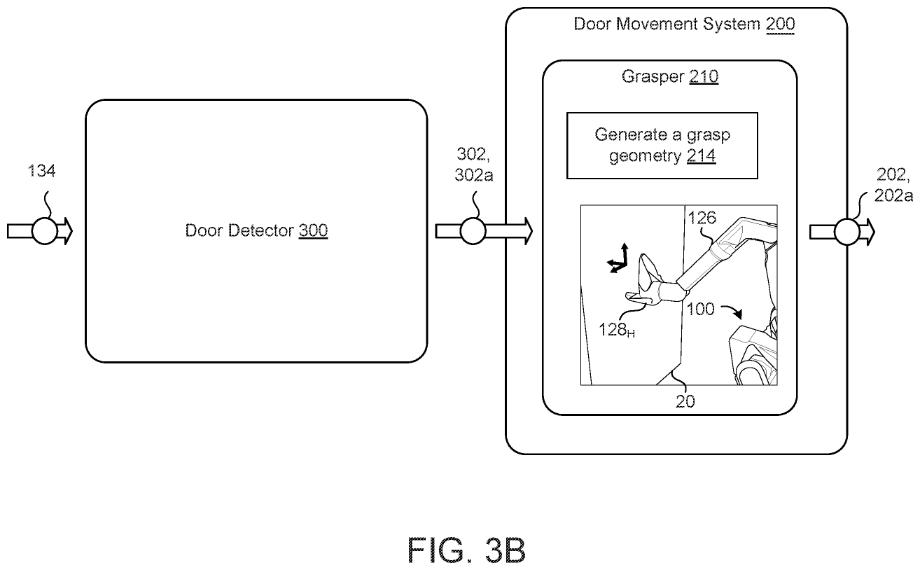

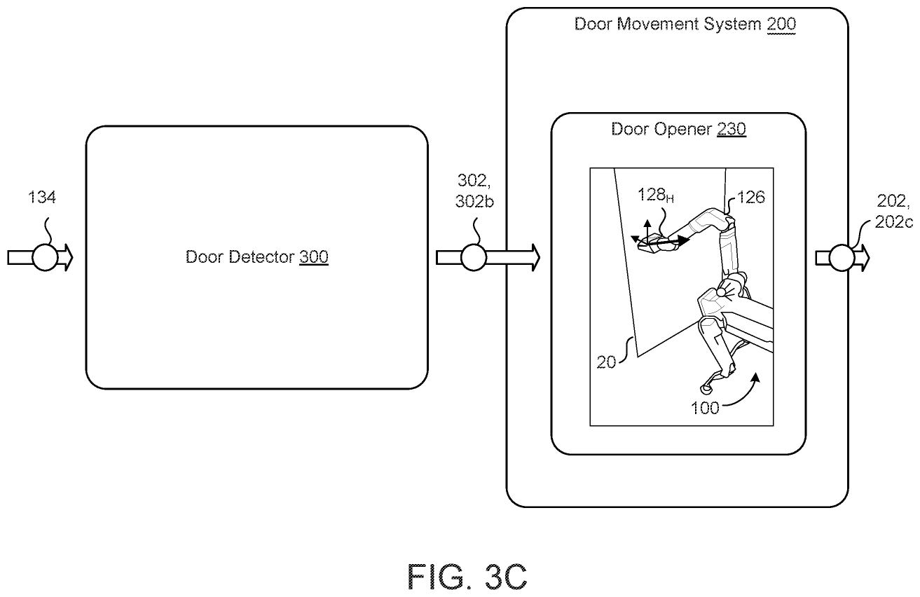

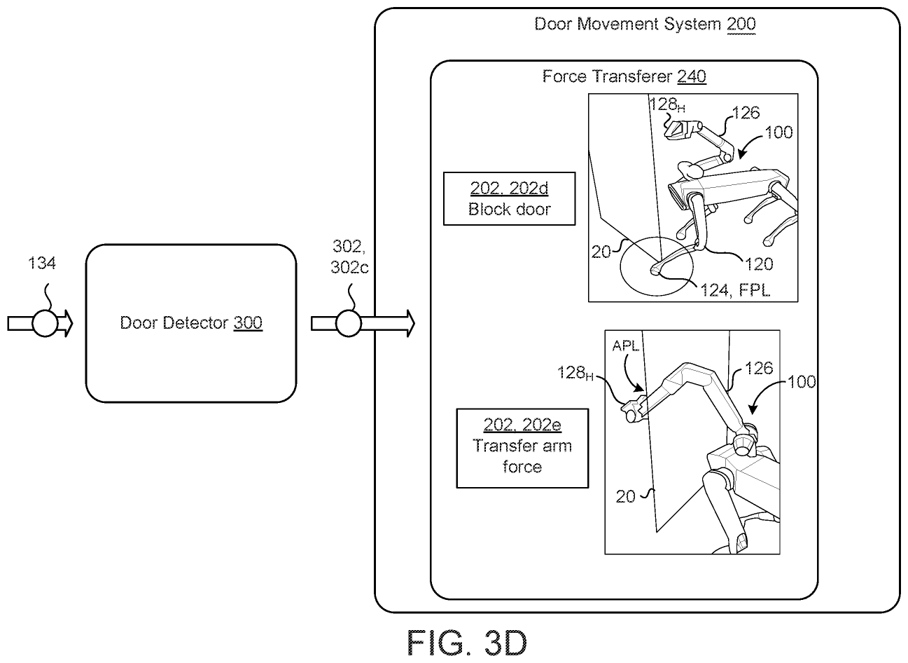

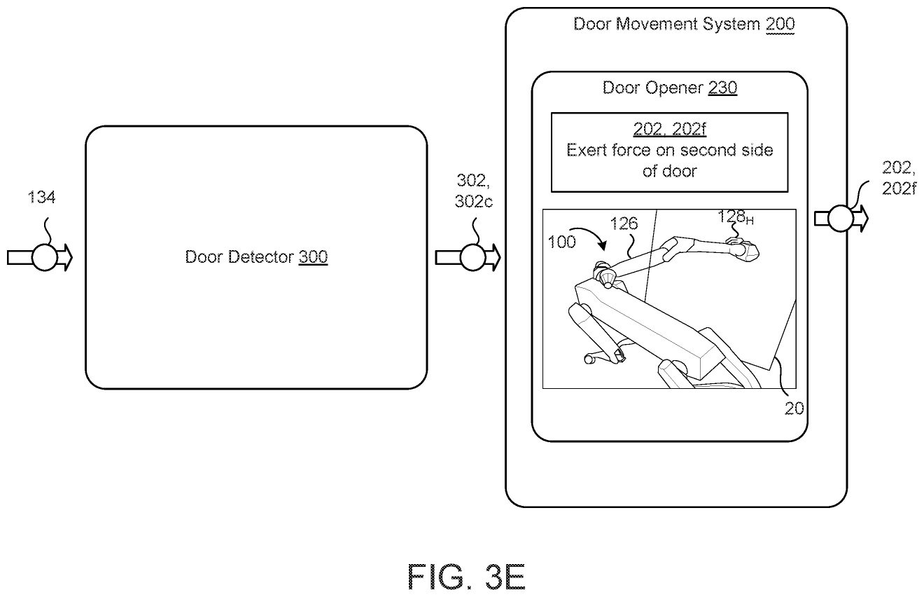

Referring to FIG. 3A, in some implementations, the door detector 300 includes a detector model 310. The detector model 310 can receive sensor data 134 and generate one or more predicted door properties 302 (e.g., to characterize a current state 304 of the door 20). In some examples, the detector model 310 is a machine learning model that is trained to generate the predicted door property 302. For instance, the model 310 may be trained (e.g., shown in the training stage portion of FIG. 3A) prior to inference where the model 310 is trained based on (e.g., using) supervised training data 312 to predict door properties 302. Further, the training data 312 can include training data labels 314 that indicate one or more door properties associated with respective portion of the training data 312 so that the model 310 learns an association between aspects of the training data 312 and the labels 314 indicating the door properties. For example, the sensor data 134 may include image data (e.g., a two-dimensional image captured by a sensor 132 of the robot 100) and the training data 312 may include a plurality of training samples where each training sample includes corresponding training image data and a respective label 314 indicating respective door properties present in the image data. Further, the training image data of the training data 312 may indicate a door 20 and the training image may include a label 314 indicating with a door width, a grasp ray (e.g., a ray that traces a path to the handle 26 of the door 20), a grasp type (e.g., designated a way to grasp a type of handle 26), a swing direction for the door 20, and/or a door handedness of the door 20. Since the model 310 may receive a plurality labeled images as training samples 312 during the training process, the model 310 can learn how to generate a predicted door property 302. The trained model 310 can receive sensor data 134 that is not labeled (e.g., image data without labels) as input and generate predicted door properties 302 as output. Therefore, the trained model 310 can generate one or more predicted door properties 302 for a door 20 that the robot 100 has not previously seen (or perceived) from sensor data 134 captured for the door 20. The training data 312 may also include negative training samples that include image data with labels 314 not indicating any door properties, or otherwise, indicating that the negative training sample does not include a door. For instance, a training image depicting a window in a dwelling may include a negative training label 314 that enforces the model 310 to learn to not detect the presence of the door when windows encountered during inference.

FIGS. 3B-3E are examples of how the door movement system 200 can use the one or more predicted door properties 202 to generate a particular operation 202 for the robot 100 to execute. For instance, the grasper 210 can generate a first operation 202a for the hand member 128_{H} of the arm 126 that controls the hand member 128_{H} of the arm 126 to grasp the handle 26 of the door 20. To grab the handle 26, the door detector 300 can generate a grasping ray 302, 302a as a predicted door property 302 from the sensor data 134. A grasping ray 302a or handle detection ray corresponds to a ray that indicates an estimated spatial location of the door handle 26 relative to the hand member 128_{H} of the arm 126 of the robot 100. The grasping ray 302a may be a line that terminates at an estimated spatial location for the door handle 26 to define a path for the hand member 128_{H} to follow to grasp the handle 26. In some implementations, the sensor data 134 includes the door handle 26 as a feature 212 of the door 20 to enable the door detector 300 to predict the grasping ray 302a.

In some cases, to grab the handle 26, the door detector 300 can generate a classification of the handle 26. For example, the door detector 300 can generate the classification of the handle from the sensor data 134. The classification of the handle 26 may indicate that the handle 26 includes at least one of a pushbar, handle, a knob, a button, a switch, a motion detector, an audio detector, a keypad, etc. The door detector 300 may define the classification of the handle 26 to enable the hand member 128_{H} to determine how to interact with (e.g., grasp) the handle 26. For example, the hand member 12811 may interact with different handles differently (e.g., the hand member 128_{H} may grasp a pushbar and a handle differently). In some cases, the hand member 128_{H} may utilize the classification of the handle 26 and/or the spatial location of the handle 26 to determine how to interact with the handle 26.

In FIG. 3C, the door detector 300 receives sensor data 134 and generates a handedness 302, 302b for the door 20 as the predicted door property 302. For instance, the sensor data 134 indicates one or more hinges 22 for the door 20. Handedness for a door 20 may indicate the direction that the door 20 will swing in order to open/close and/or the location of the hinges 22 for the door 20. When the handedness 302b indicates that the door 20 opens by swinging in a direction toward the robot 100, the door movement system 200 (e.g., at the door opener 230) can generate a door movement operation 202c that exerts a pull force (e.g., on the handle 26) with the hand member 128_{H} of the arm 126. In contrast, when the handedness 302b indicates that the door 20 opens by swinging in a direction away from the robot 100, the door movement system 200 (e.g., at the door opener 230) can generate a door movement operation 202c that exerts a push force (e.g., on a grasped handle 26) with the hand member 128_{H} of the arm 126. If the door movement system 200 receives a predicted door property 302 that defines the handedness 302b of the door 20, the door movement system 200 may not perform its own detection operations to determine which direction the door 20 opens.

Referring to FIGS. 3D and 3E, the door detector 300 receives sensor data 134 and generates an estimated door width 302, 302c as the predicted door property 302. In some examples, to generate the estimated door width 302c, the door detector 300 receives information identifying the door frame 24 of the door 20 captured by the sensor data 134. As FIGS. 3D and 3E illustrate, the door movement system 200 can use the estimated door width 302c to perform different operations 202. For instance, the force transferer 240 can use the estimated door width 302c to generate an operation 202d that positions a distal end (e.g., a foot 124) of one of the legs 120 of the robot 100 at a foot placement location FPL. The foot placement location FPL refers to a location where the robot 100 positions the distal end (e.g., a foot 124) of one of its legs 120 to block the door 20 from swinging in a door closing direction. In some configurations, the foot placement location FPL for fourth operation 202d is based on the voxel occupancy of the door 20 during the door movement operation. Therefore, the foot placement location FPL may be updated, modified, or entirely disregarded based on the position/location of the door 20 according to other system of the robot 100 (e.g., the perception system).

Furthermore, in some configurations, with the estimated door width 302c, the door movement system 200 may generate an operation 202e to transfer a force being exerted by the arm 126 from one side of the door 20 to another side of the door 20. In order to transfer the force in this manner, the force transferer 240 may use the estimated door width 302c to determine an arm placement location APL. An arm placement location APL can refer to a location where the hand member 128_{H} contacts the other side of the door 20. In some examples, the arm placement location APL accounts for the length of the arm 126 with respect to the estimated door width 302c in order to place the arm 126 at a relatively optimal position for the arm 126 to exert a force on the door 20 and (e.g., simultaneously) for the robot 100 to walk through the doorway. When the arm 126 is positioned in the arm placement location during the fifth operation 202e, the arm 126 may be positioned in a manner where the arm 126 hooks the hand member 128_{H} around the edge 20e of the door 20 such that the arm 126 extends from the first side of the door 20 around the edge 20e of the door 20 to a second side of the door 20. In some examples, the hooking operation causes members 128 of the arm 126 to be in contact with different sides of the door 20.

In some examples, the estimated door width 302c serves as a property 302 that advises the robot 100 as to a location of the door 20 as the door 20 moves. The robot 100 can utilize the estimated door width 302c to identify an angle of the door 20 in the current state 304. With the angle of the door 20 being defined by the estimated door width 302c, the robot 100 may manage the door movement force as a function of the door angle. Therefore, the estimated door width 302c factors into an operation 202f that exerts force on a second side of the door 20 while the robot 100 is walking through the doorway. As compared to the force transferer 240, the hand member 128_{H} may be the part (e.g., the only part) of the arm 126 that is contacting the door 20.

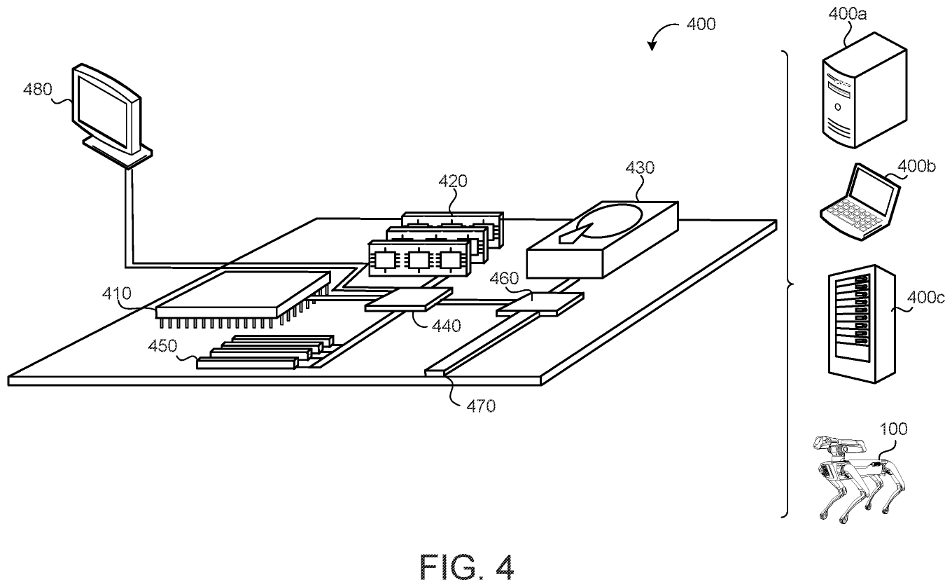

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (e.g., data processing hardware 142, 162), memory 420 (e.g., memory hardware 144, 164), a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Furthermore, the elements and acts of the various embodiments described above can be combined to provide further embodiments. Indeed, the methods and systems described herein may be embodied in a variety of other forms; furthermore, various omissions, substitutions and changes in the form of the methods and systems described herein may be made without departing from the spirit of the disclosure. Accordingly, other implementations are within the scope of the following claims.

What is claimed is:

1. A computer-implemented method that when executed by data processing hardware of a robot causes the data processing hardware to perform operations comprising:
receiving, from a sensor of a robot, sensor data associated with at least a portion of a door;
determining, using the sensor data, one or more door properties of the door; and
generating, using the one or more door properties, a door movement operation executable by the robot to move the door.

2. The method of claim 1, wherein determining the one or more door properties comprises executing a door detection model configured to:
receive, as input, the sensor data; and
generate, as output, the one or more door properties.

3. The method of claim 1, wherein the sensor data comprises image data associated with at least one of a door frame, a door handle, a door hinge, a door knob, or a door pushbar.

4. The method of claim 1, wherein the one or more door properties comprise at least one of a door width, a grasp search ray, a grasp type, a swing direction, or a door handedness.

5. The method of claim 1, wherein:
the sensor data is associated with at least a portion of a door frame;
the one or more door properties comprise an estimated door width; and
the door movement operation comprises positioning a distal end of a leg of the robot in a placement location to block the door from swinging in a particular direction.

6. The method of claim 1, wherein:
the sensor data is associated with at least a portion of a door frame;
the one or more door properties comprise an estimated door width; and
the door movement operation comprises positioning an end-effector of a manipulator arm of the robot at an arm placement location on the door,
wherein positioning the end-effector at the arm placement location comprises hooking the end-effector around an edge of the door, wherein the manipulator arm extends from a first side of the door around an edge of the door to a second side of the door.

7. The method of claim 1, wherein:
the sensor data is associated with at least a portion of a door frame;
the one or more door properties comprise an estimated door width; and
the door movement operation comprises positioning an end-effector of a manipulator arm of the robot at an arm placement location on the door, wherein the end-effector of the manipulator arm exerts a push force at a location on the door corresponding to the arm placement location to enable the robot to traverse the door.

8. The method of claim 1, wherein:
the sensor data is associated with at least a portion of a door handle;
the one or more door properties comprise a grasping ray indicating an estimated spatial location of the door handle relative to an end-effector of a manipulator arm of the robot; and
the door movement operation comprises grasping the door handle with the end-effector at the estimated spatial location.

9. The method of claim 1, wherein:
the sensor data is associated with at least a portion of a door handle;
the one or more door properties comprise a classification of the door handle; and
the door movement operation comprises grasping the door handle with the end-effector based on the classification of the door handle.

10. The method of claim 1, wherein:
the sensor data is associated with at least a portion of a door handle;
the one or more door properties comprise a classification of the door handle; and
the door movement operation comprises grasping the door handle with the end-effector based on the classification of the door handle, wherein the classification of the door handle indicates the door handle comprises at least one of a pushbar, a handle, or a knob.

11. The method of claim 1, wherein:
the sensor data is associated with at least a portion of a door hinge;
the one or more door properties comprise a door handedness; and
the door movement operation comprises exerting a pull force with an end-effector of a manipulator arm of the robot based on determining that the one or more door properties indicate that the door opens by swinging in a direction towards the robot.

12. The method of claim 1, wherein:
the sensor data is associated with at least a portion of a door hinge;
the one or more door properties comprise a door handedness; and
the door movement operation comprises exerting a push force with an end-effector of a manipulator arm of the robot based on determining that the one or more door properties indicate that the door opens by swinging in a direction away from the robot.

13. The method of claim 1, wherein:
the robot comprises an manipulator arm, the manipulator arm including an end-effector; and
the sensor is located on the end-effector

14. The method of claim 1, wherein the sensor is located on a body of the robot.

15. The method of claim 1, wherein the robot comprises four legs, each of the four legs coupled to a body of the robot.

16. The method of claim 1, wherein the one or more door properties identify a state of the door as a fully open state, a partially open state, or a closed state.

17. The method of claim 1, wherein the operations further include executing the door movement operation to move the robot according to the door movement operation.

18. The method of claim 1, wherein the door movement operation is executed by the robot without human intervention.

19. A robot comprising:
a body;
two or more legs coupled to the body;
a robotic manipulator coupled to the body;
a sensor;
data processing hardware; and
memory hardware in communication with the data processing hardware, the memory hardware storing instructions that when executed on the data processing hardware cause the data processing hardware to perform operations comprising:
receiving, from the sensor, sensor data associated with at least a portion of a door;
determining, using the sensor data, one or more door properties of the door; and
generating, using the one or more door properties, a door movement operation executable by the robot to control the robotic manipulator to move the door.

20. The robot of claim 19, wherein determining the one or more door properties comprises executing a door detection model configured to:
receive, as input, the sensor data; and
generate, as output, the one or more door properties.

21. The robot of claim 19, wherein the sensor data comprises image data associated with at least one of a door frame, a door handle, a door hinge, a door knob, or a door pushbar.

22. The robot of claim 19, wherein the one or more door properties comprise at least one of a door width, a grasp search ray, a grasp type, a swing direction, or a door handedness.

23. The robot of claim 19, wherein:
the sensor data is associated with at least a portion of a door frame;
the one or more door properties comprise an estimated door width; and
the door movement operation comprises positioning a distal end of a leg of the robot in a placement location to block the door from swinging in a particular direction.

24. The robot of claim 19, wherein:
the sensor data is associated with at least a portion of a door frame;
the one or more door properties comprise an estimated door width; and
the door movement operation comprises positioning an end-effector of a manipulator arm of the robot at an arm placement location on the door,
wherein positioning the end-effector at the arm placement location comprises hooking the end-effector around an edge of the door, wherein the manipulator arm extends from a first side of the door around an edge of the door to a second side of the door.

25. The robot of claim 19, wherein:
the sensor data is associated with at least a portion of a door frame;
the one or more door properties comprise an estimated door width; and
the door movement operation comprises positioning an end-effector of a manipulator arm of the robot at an arm placement location on the door, wherein the end-effector of the manipulator arm exerts a push force at a location on the door corresponding to the arm placement location to enable the robot to traverse the door.

26. The robot of claim 19, wherein:
the sensor data is associated with at least a portion of a door handle;
the one or more door properties comprise a grasping ray indicating an estimated spatial location of the door handle relative to an end-effector of a manipulator arm of the robot; and
the door movement operation comprises grasping the door handle with the end-effector at the estimated spatial location.

27. The robot of claim 19, wherein:
the sensor data is associated with at least a portion of a door handle;
the one or more door properties comprise a classification of the door handle; and
the door movement operation comprises grasping the door handle with the end-effector based on the classification of the door handle.

28. The robot of claim 19, wherein:
the sensor data is associated with at least a portion of a door handle;
the one or more door properties comprise a classification of the door handle; and
the door movement operation comprises grasping the door handle with the end-effector based on the classification of the door handle, wherein the classification of the door handle indicates the door handle comprises at least one of a pushbar, a handle, or a knob.

29. The robot of claim 19, wherein:
the sensor data is associated with at least a portion of a door hinge;
the one or more door properties comprise a door handedness; and
the door movement operation comprises exerting a pull force with an end-effector of a manipulator arm of the robot based on determining that the one or more door properties indicate that the door opens by swinging in a direction towards the robot.

30. The robot of claim 19, wherein:
the sensor data is associated with at least a portion of a door hinge;
the one or more door properties comprise a door handedness; and
the door movement operation comprises exerting a push force with an end-effector of a manipulator arm of the robot based on determining that the one or more door properties indicate that the door opens by swinging in a direction away from the robot.

31. The robot of claim 19, wherein:
the robot comprises an manipulator arm, the manipulator arm including an end-effector; and
the sensor is located on the end-effector

32. The robot of claim 19, wherein the sensor is located on a body of the robot.

33. The robot of claim 19, wherein the robot comprises four legs coupled, each of the four legs coupled to a body of the robot.

34. The robot of claim 19, wherein the one or more door properties identify a state of the door as a fully open state, a partially open state, or a closed state.

35. The robot of claim 19, wherein the operations further include executing the door movement operation to move the robot according to the door movement operation.

36. The robot of claim 19, wherein the door movement operation is executed by the robot without human intervention.
